(19) United States
(12) Patent Application Publication
(10) Pub. No.: US 2020/0372489 A1
(43) Pub. Date: Nov. 26, 2020

(54) RESOURCE TRANSFER BASED ON NEAR FIELD COMMUNICATION

(71) Applicant: BEIJING SANKUAI ONLINE TECHNOLOGY CO., LTD, Beijing (CN)

(72) Inventors: Feng LIU, Beijing (CN); Qi ZHAO, Beijing (CN)

(21) Appl. No.: 16/988,572

(22) Filed: Aug. 7, 2020

Related U.S. Application Data
(63) Continuation-in-part of application No. PCT/CN2018/125950, filed on Dec. 30, 2018.

(30) Foreign Application Priority Data
Feb. 7, 2018 (CN) 201810123291.1
Feb. 7, 2018 (CN) 201810124221.8

(51) Int. Cl. G06Q 20/32; H04W 4/80; H04W 4/029; G06Q 20/10; G06Q 20/38

(52) U.S. Cl. CPC G06Q 20/3278; H04W 4/80; H04W 4/029; G06Q 2220/00; G06Q 20/3825; G06Q 20/3224; G06Q 20/3829; G06Q 20/10

(57) ABSTRACT

The present application provides a resource transfer method based on near field communication. The method includes: acquiring a user identifier of a current login user in a first resource management client by a resource transfer terminal of a target merchant in response to triggering of the first resource management client, and outputting target merchant authentication information; in response to determining that the resource transfer terminal has enabled a fixed quantity resource transfer mode, generating a resource transfer order according to a preset quantity of resources transferred by a single order; and adding a user signature and a merchant signature to the resource transfer order, and then accepting the resource transfer order with the signatures.

### CROSS-REFERENCE TO RELATED APPLICATIONS

This patent application is a continuation-in-part of an international application No. PCT/CN2018/125950 filed on Dec. 30, 2018, and the international application claims priority to Chinese Patent Application No. 201810123291.1, entitled “Target User Position Information Management Method, Device and System and Electronic Equipment”, filed on Feb. 7, 2018, and Chinese Patent Application No. 201810124221.8, entitled “Resource Transfer Method, Device and System Based on Near Field Communication and Electronic Equipment”, filed on Feb. 7, 2018. All of these applications are incorporated herein by reference in entirety.

### TECHNICAL FIELD

The disclosure relates to the technical field of computers, and more particularly to resource transfer based on near field communication and target user position information management.

### BACKGROUND

With the development of near field communication (NFC) technology, data transmission and payment based on near field communication gradually enter daily life of people, for example, the use of a near field communication acceptance terminal. A user can transmit data or other resources through a mobile phone with a built-in near field communication module and the near field communication acceptance terminal by means of near field communication. For example, the user performs order payment through a near field communication acceptance terminal of a merchant to realize monetary resource transfer. However, the near field communication acceptance terminal is high in cost and needs to be connected to a network, so that an application scenario is limited, and the near field communication acceptance terminal is not widely used at present.

### SUMMARY

In an aspect, an embodiment of the disclosure provides a resource transfer method based on near field communication, applied to a resource transfer terminal including a near field communication module. The method includes:

acquiring a user identifier of a current login user in a first resource management client by a resource transfer terminal of a target merchant according to the triggering of the first resource management client;

in response to determining that the resource transfer terminal has enabled a fixed quantity resource transfer mode, generating a resource transfer order by the resource transfer terminal according to a preset quantity of resources transferred by a single order

adding a merchant signature of the target merchant and a user signature generated according to the acquired user identifier to the resource transfer order by the resource transfer terminal, and accepting the resource transfer order with the signatures; and

sending an acceptance state of the resource transfer order with the signatures to the first resource management client by the resource transfer terminal by means of near field communication.

The fixed quantity resource transfer mode and the quantity of resources transferred by each order are set according to data sent by a second resource management client.

In another aspect, an embodiment of the present disclosure provides a target merchant position information management method based on near field communication, including:

acquiring at least one resource transfer order stored in a resource transfer terminal by a second resource management client; and

managing position information of a target merchant by the second resource management client according to information included in the resource transfer order.

The information included in the resource transfer order at least includes a geographic position.

In another aspect, an embodiment of the present disclosure further discloses electronic equipment, including a storage medium, a processor and a machine executable instruction stored in the storage medium and capable of running on the processor. When the processor executes the machine executable instruction, the following operations are implemented:

acquiring at least one resource transfer order stored in a resource transfer terminal; and

managing position information of a target merchant according to information included in the resource transfer order.

The information included in the resource transfer order at least includes a geographic position.

### BRIEF DESCRIPTION OF THE DRAWINGS

To describe the technical solutions in the embodiments of this disclosure more clearly, the following briefly describes the accompanying drawings required for describing the embodiments. Apparently, the accompanying drawings in the following description show merely some embodiments of the present invention, and a person of ordinary skill in the art can still derive other drawings from these accompanying drawings without creative efforts.

FIG. 1 is a flow diagram of a resource transfer method according to Embodiment 1 of the disclosure.

FIG. 2 is a flow diagram of a modified embodiment of the resource transfer method according to Embodiment 1 of the disclosure.

FIG. 3 is a flow diagram of a resource transfer method according to Embodiment 2 of the disclosure.

FIG. 4 is a flow diagram of a modified embodiment of the resource transfer method according to Embodiment 2 of the disclosure.

FIG. 5 is a flow diagram of a resource transfer method according to Embodiment 3 of the disclosure.

FIG. 6 is a flow diagram of a modified embodiment of the resource transfer method according to Embodiment 3 of the disclosure.

FIG. 7 is a schematic structure diagram of a resource transfer device according to Embodiment 4 of the disclosure.

FIG. 8 is a schematic structure diagram of a modified embodiment of the resource transfer device according to Embodiment 4 of the disclosure.

FIG. 9 is a schematic structure diagram of a resource transfer device according to Embodiment 5 of the disclosure.

FIG. 10 is a schematic structure diagram of a modified embodiment of the resource transfer device according to Embodiment 5 of the disclosure.

FIG. 11 is a schematic structure diagram of a resource transfer device according to Embodiment 6 of the disclosure.

FIG. 12 is a schematic structure diagram of a modified embodiment of the resource transfer device according to Embodiment 6 of the disclosure.

FIG. 13 is a schematic structure diagram of a resource transfer system according to Embodiment 7 of the disclosure.

FIG. 14 is a first schematic diagram of a work flow of the system shown in FIG. 13.

FIG. 15 is a flow diagram of a target merchant position information management method according to Embodiment 8 of the disclosure.

FIG. 16 is a schematic structure diagram of a target merchant position information management system according to Embodiment 9 of the disclosure.

FIG. 17 is a flow diagram of specific application of a target merchant position information management method in the system shown in FIG. 16.

FIG. 18 is a first schematic structure diagram of a target merchant position information management device according to Embodiment 10 of the disclosure.

FIG. 19 is a second schematic structure diagram of the target merchant position information management device according to Embodiment 10 of the disclosure.

### DETAILED DESCRIPTION

The following clearly and completely describes the technical solutions in the embodiments of the disclosure with reference to the accompanying drawings in the embodiments of the disclosure. Apparently, the described embodiments are merely some but not all of the embodiments of the disclosure. All other embodiments obtained by a person of ordinary skill in the art based on the embodiments of the disclosure without creative efforts shall fall within the protection scope of the disclosure.

### Embodiment 1

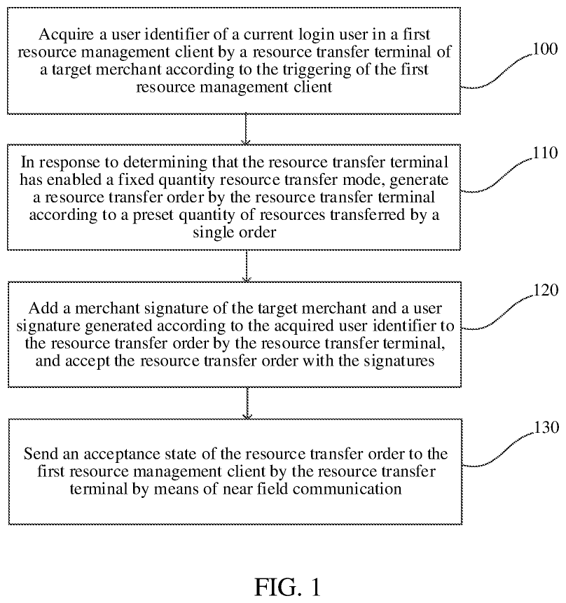

A resource transfer method based on near field communication disclosed by the present embodiment is applied to a resource transfer terminal. The resource transfer terminal includes a near field communication module. As shown in FIG. 1, the method includes step 100 to step 130.

Step 100, a resource transfer terminal of a target merchant acquires a user identifier of a current login user in a first resource management client according to the triggering of the first resource management client.

The resource transfer terminal includes a casing and the near field communication module. The resource transfer terminal is equipment of the target merchant. During specific implementation, the resource transfer terminal is optionally portable equipment with a built-in near field communication module, such as a card or a name plate. The resource transfer terminal is preset with a merchant signature of the target merchant and target merchant authentication information. The target merchant authentication information is optionally a merchant name or an icon, etc. The merchant signature is a numeral string generated according to a merchant identifier of the target merchant. The merchant identifier is a unique identifier acquired by the target merchant through a resource management platform.

The first resource management client is an application client of the resource management platform. During specific application, in a possible implementation, the first resource management client is application software installed in equipment with a near field communication module, such as a mobile phone of a user. In another possible implementation, the first resource management client is user equipment with a near field communication module. In the present embodiment, illustration is performed by taking a condition that the first resource management client is the application software installed in the equipment with the near field communication module, such as the mobile phone of the user, as an example.

In response to that the user wants to transfer resources with the target merchant by means of near field communication, for example, the user wants to perform order payment to the merchant by means of near field communication, the user logs in the first resource management client installed in the mobile phone enabling a near field communication function, and then initiates a payment flow process. The first resource management client may transmit a signal for reading the resource transfer terminal through a near field communication module on the mobile phone.

The near field communication module of the resource transfer terminal senses the signal for reading the resource transfer terminal, processes the received signal, analyzes information sent by the first resource management client by means of near field communication, and obtains the user identifier of the current login user in the first resource management client, and an acquiring instruction which is configured to acquire locally stored merchant authentication information (i.e., the target merchant authentication information). The resource transfer terminal outputs the locally stored authentication information (i.e., the target merchant authentication information), and stores the resolved user identifier, i.e., the user identifier of the current login user in the first resource management client.

Step 110, in response to determining that the resource transfer terminal has enabled a fixed quantity resource transfer mode, the resource transfer terminal generates a resource transfer order according to a preset quantity of resources transferred by a single order.

The fixed quantity resource transfer mode refers to a resource transfer mode of transferring a fixed quantity of resources by a single order. Additionally, the fixed quantity resource transfer mode and the quantity of resources transferred by a single order are set according to data sent by a second resource management client.

During specific implementation, the quantity of resources transferred by a single order is sent to the resource transfer terminal through the second resource management client to realize transfer of a fixed quantity of resources by a single order. In response to that the resource transfer terminal receives the fixed quantity of resources transferred by a single order sent by the second resource management client, the fixed quantity of resources transferred by a single order is locally stored, and the fixed quantity resource transfer mode is enabled.

In response to that the user initiates a resource transfer flow process through the first resource management client, and then moves close to the resource transfer terminal to request to read the target merchant authentication information stored in the resource transfer terminal, the first resource management client sends a starting signal to the resource transfer terminal. The starting signal carries the user identifier of the current login user in the first resource management client. The near field communication module of the resource transfer terminal starts at an induced voltage generated in response to the starting signal sent by the first resource management client, and extracts the user identifier carried in the starting signal. At the same time, the resource transfer terminal judges whether the resource transfer mode of transferring the fixed quantity of resources by a single order is enabled. In response to that it is determined that the resource transfer mode of transferring the fixed quantity of resource by a single order has been enabled, the resource transfer terminal generates the resource transfer order according to a locally prestored fixed quantity of resources transferred by a single order.

Step 120, the resource transfer terminal adds a merchant signature of the target merchant and a user signature generated according to the acquired user identifier to the resource transfer order, and accepts the resource transfer order with the signatures.

The resource transfer terminal generates the user signature according to the acquired user identifier. The user identifier is a user identifier of a resource transfer-out user. Additionally, the merchant signature of the target merchant is prestored in the resource transfer terminal. Correspondingly, this step includes: the resource transfer terminal generates a user signature of the resource transfer-out user according to the user identifier of the resource transfer-out user, and adds the locally prestored merchant signature of the target merchant and the user signature of the resource transfer-out user to the resource transfer order.

It should be noted that the process of accepting the resource transfer order with the signatures by the resource transfer terminal refers to the process of locally storing the resource transfer order with the signatures by the resource transfer terminal.

Step 130, the resource transfer terminal sends an acceptance status of the resource transfer order to the first resource management client by means of near field communication.

The acceptance status of the resource transfer order includes a successful acceptance state of the resource transfer order or a failed acceptance state of the resource transfer order. The resource transfer terminal locally stores the resource transfer order with the signatures. In response to a condition that the resource transfer order is successfully stored, the resource transfer terminal outputs successful acceptance information of the resource transfer order to the first resource management client. The successful acceptance information of the resource transfer order represents that the acceptance status of the resource transfer order is the successful state. In response to that the storage of the resource transfer order fails, the resource transfer terminal outputs failed acceptance information of the resource transfer order to the first resource management client. The failed acceptance information of the resource transfer order represents that the acceptance status of the resource transfer order is the failed state.

The resource transfer terminal is passive equipment, and power is supplied through an induced voltage generated in response to an induced signal of the first resource management client. Therefore, in order to improve the order generating efficiency, the quantity of resources of a single transfer order is optionally preset. When the user performs offline resource transfer through resource transfer equipment, the resource transfer quantity does not need to be input. A fixed quantity of resource transfer can be realized only by moving close to the resource transfer terminal for reading, and the resource transfer efficiency is greatly improved. Generally, for example, when the user performs payment by scanning a two-dimensional code, the mobile phone of the user needs to be connected to a network. By using the resource transfer method based on near field communication disclosed by the embodiment of the disclosure, the order payment can be realized without connecting the mobile phone of the user to the network, so that great convenience on the payment is provided for the user.

Hereto, the user completes offline resource transfer once with the target merchant through a terminal with the built-in near field communication module.

According to the resource transfer method based on near field communication disclosed by the embodiment of the disclosure, the resource transfer terminal of the target merchant acquires the user identifier of the current login user in the first resource management client according to the triggering of the first resource management client. At the same time, in response to determining that the resource transfer terminal has enabled the fixed quantity resource transfer mode, the resource transfer terminal generates the resource transfer order according to the preset quantity of resources transferred by a single order, adds the user signature and the merchant signature to the resource transfer order, and then stores the resource transfer order with the signatures. The problems of limited use scenario and high cost of the resource transfer method in the prior art are solved.

According to the resource transfer method based on near field communication disclosed by the embodiment of the disclosure, resource transfer can be completed by means of near field communication under the condition that the mobile phone of the user is not connected to the network. At the same time, the resource transfer terminal does not need to be connected to the network, and the use scenario is not limited. Additionally, a host machine of the first resource management terminal in the disclosure is optionally the mobile phone with the near field communication function. The resource transfer terminal only needs to include the near field communication module, for example, is optionally an electronic card with the near field communication module. The cost is very low. Wide application is facilitated. The near field communication module can realize self-power supply after sensing a radio frequency signal, additionally, a certain storage space exists in the near field communication module, and a control program can be developed on an embedded secure element included in the near field communication module. Therefore, the resource transfer terminal can complete reception of the resource transfer order, store the resource transfer order and complete offline resource transfer.

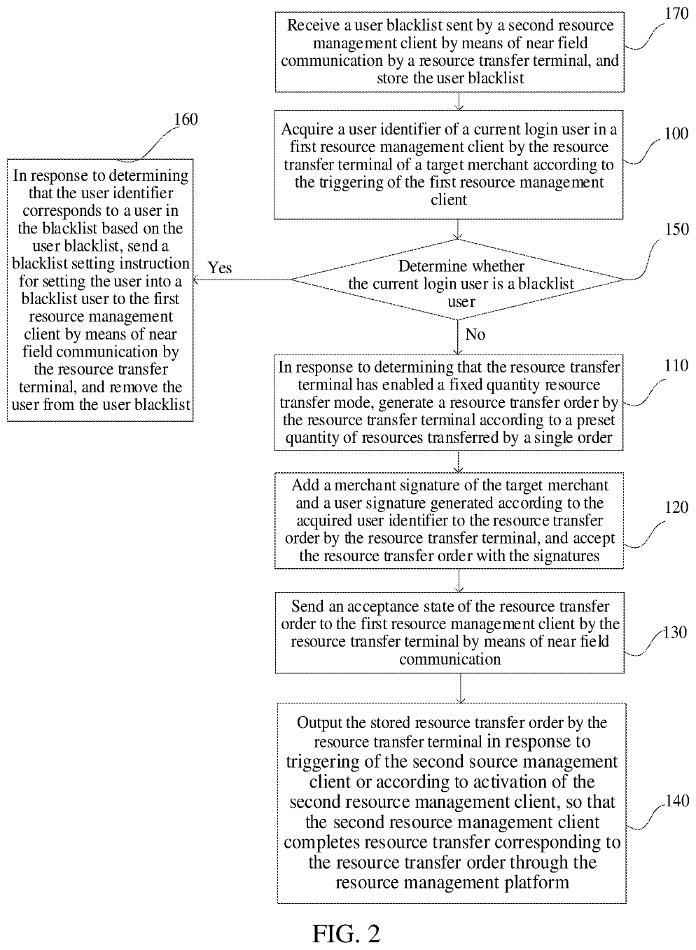

In one modification of the present embodiment, as shown in FIG. 2, the method further includes:

Step 140, the resource transfer terminal outputs the stored resource transfer order in response to triggering of the second source management client or according to activation of the second resource management client, so that the second resource management client completes resource transfer corresponding to the resource transfer order through the resource management platform.

During specific implementation, the second resource management client is optionally an application program running on a mobile phone of the target merchant (such as a merchant) with a near field communication module, or is other equipment with a near field communication module. The second resource management client optionally reads resource transfer order data stored in the resource transfer terminal by means of near field communication in real time or in regular time.

In an application where the second resource management client is an application program running on the mobile phone of the merchant with the near field communication module as an example, in response to that the target merchant moves the mobile phone close to the resource transfer terminal, the resource transfer terminal starts under the effect of the induced voltage generated in response to the induced signal of the mobile phone, and outputs the locally stored resource transfer order according to the received instruction for reading the resource transfer order sent by the second resource management client. The second resource management client further sends the read resource transfer order to the resource management platform through the network. The resource management platform analyzes the resource transfer order, and transfers the specified quantity of resources from an account of the transfer-out user to an account of the target merchant according to information in each resource transfer order, so as to complete resource transfer. The specified quantity is the quantity of resources to be transferred in the resource transfer order.

By taking code scanning payment as an example, the user needs to be connected to a network to perform code scanning payment, so that the application scenario is limited. By using the resource transfer method based on near field communication disclosed by the embodiment of the present disclosure, offline resource transfer is realized between users by using the resource transfer terminal as a medium. The problem that the resource transfer can only be completed under the network connected condition by a resource transfer-out user and a resource transfer-in user is solved, convenience is provided for the resource transfer of the users, and the application scenarios of the resource transfer are expanded. Additionally, the resource transfer terminal is used as the medium between the users, the resource transfer is performed by means of near field communication, and the security is higher.

In one modification of the present embodiment, as shown in FIG. 2, after the step that the resource transfer terminal of the target merchant acquires the user identifier of the current login user in the first resource management client according to the triggering of the first resource management client, the step that the resource transfer terminal receives the resource transfer order sent by the first resource management client by means of near field communication is further included.

In response to a condition that the first resource management client receives the target merchant authentication information sent by the resource transfer terminal, generally, the first resource management client may show information of the target merchant according to the target merchant authentication information. In response to that the target merchant authentication information is an icon of the target merchant or an authentication icon of the resource management platform, the first resource management client shows the icon of the target merchant or the authentication icon of the resource management platform for the current login user to confirm. Then, the first resource management client acquires the resource transfer quantity input by the user, such as a payment amount. After the user confirms the payment order, the resource transfer order is generated according to the user identifier of the user, the resource transfer quantity, the current system time, information corresponding to the resource and the like. The generated resource transfer order is sent to the resource transfer terminal by means of near field communication. The resource transfer terminal may receive the resource transfer order sent by the first resource management client by means of near field communication.

The resource transfer terminal adds the merchant signature of the target merchant and the user signature generated according to the user identifier to the resource transfer order, and accepts the resource transfer order with the signatures.

The resource transfer terminal generates the user signature of the current login user of the first resource management client according to a preset rule according to the user identifier of the current login user of the first resource management client. Then, the resource transfer terminal adds the signatures to the received resource transfer order, including adding the user signature generated according to the user identifier of the current login user of the first resource management client and the signature of the target merchant (i.e., the merchant signature) stored in the resource transfer terminal, and accepts the resource transfer order with the signatures. The step of accepting the resource transfer order with the signatures by the resource transfer terminal includes: the resource transfer terminal locally stores the resource transfer order with the signatures.

The resource transfer terminal sends the acceptance status of the resource transfer order to the first resource management client by means of near field communication.

The resource transfer terminal sends the successful acceptance state of the resource transfer order to the first resource management client by means of near field communication according to a storage result of the resource transfer order. For example, after the resource transfer terminal successfully stores the resource transfer order, the successful acceptance information of the order is sent to the first resource management client by means of near field communication. The successful acceptance information of the order is used to identify that the acceptance status of the resource transfer order is the successful state. In response to that the storage of the resource transfer order fails, the resource transfer terminal sends failed acceptance information of the order to the first resource management client by means of near field communication. The failed acceptance information of the order is used to identify that the acceptance state of the resource transfer order is the failed state.

In the embodiment of the disclosure, by sending the merchant authentication information back to the first resource management client for the user to perform identity verification on the target merchant, the security of resource transfer and the user experience can be improved. The first resource management client generates the resource transfer order, the user can manually input the resource transfer quantity, and the operation flexibility of resource transfer is improved.

It should be noted that before the resource transfer terminal locally stores the resource transfer order with the signatures, the resource transfer terminal performs encryption processing on the resource transfer order with the user signatures through a preset key.

In the embodiment of the disclosure, encrypted storage is performed on the resource transfer order by the resource transfer terminal, so the security of resource transfer can be further guaranteed.

In one modification of the present embodiment, as shown in FIG. 2, after the resource transfer terminal of the target merchant acquires the user identifier of the current login user in the first resource management client according to the triggering of the first resource management client, the method further includes:

Step 150, the resource transfer terminal determines whether the current login user is a blacklist user according to the user identifier and a prestored user blacklist. If YES, step 160 is performed.

Through the prestored user blacklist, according to the user identifier, the resource transfer terminal judges whether the current login user is the blacklist user or not. If the current login user is the blacklist user, the resource transfer terminal outputs failed resource transfer information, so that the first resource management client executes a blacklist prompt on the current login user.

The user blacklist includes the user identifier of at least one blacklist user. The resource transfer terminal determines whether the user identifier exists in the user blacklist according to the user identifier of the current login user. In response to that the user identifier exists in the user blacklist, the current login user is determined to be the blacklist user. In response to that the user identifier does not exist in the user blacklist, the current login user is determined not to be the blacklist user.

Failed resource transfer information represents that the transfer of the resource transfer order fails. The failed resource transfer information at least includes first prompt information. The first prompt information represents that the transfer of the resource transfer order fails. The failed resource transfer information further includes second prompt information. The second prompt information represents that the current login user is the blacklist user. Correspondingly, the step of outputting the failed resource transfer information by the resource transfer terminal so that the first resource management client executes the blacklist prompt on the current login user includes: the resource transfer terminal sends the failed resource transfer information to the first resource management client; and the first resource management client receives the failed resource transfer information and display the failed resource transfer information.

Step 160, in response to determining that the user identifier corresponds to the user in the blacklist based on the user blacklist, the resource transfer terminal sends a blacklist setting instruction of setting the user into the blacklist user to the first resource management client by means of near field communication, and removes the user from the user blacklist.

The first resource management client receives the blacklist setting instruction, and locally sets the user into the blacklist user according to the blacklist setting instruction. The first resource management client locally stores a user blacklist. For the convenience of description, the user blacklist in the resource transfer terminal is referred to as a first user blacklist. The user blacklist in the first resource management client is referred to as a second user blacklist. The first resource management client adds the user identifier of the user into the second user blacklist, so as to set the user into the blacklist user. After the resource transfer terminal sends the blacklist setting instruction to the first resource management client, the resource transfer terminal removes the user identifier of the user from the first user blacklist.

During specific implementation, as shown in FIG. 2, before the resource transfer terminal of the target merchant acquires the user identifier of the current login user in the first resource management client according to the triggering of the first resource management client, the method further includes:

Step 170, the resource transfer terminal receives the user blacklist sent by the second resource management client by means of near field communication, and stores the user blacklist.

During specific implementation, after successful acceptance of the offline resource transfer order, the second resource management client may read the resource transfer order in the resource transfer terminal after a period of time, and then settles accounts with the resource management platform to finally complete resource transfer. A condition that the resource quantity in the account of the resource transfer-out user is smaller than the quantity of to-be-transferred resources in the order may occur, so that the resource management platform cannot successfully complete the settlement between the transfer-out user and the target merchant. By aiming at this condition, the resource transfer method of the disclosure sets the user blacklist. When the number of times of settlement incapable of being successfully completed by the resource management platform on one transfer-out user exceeds a preset quantity, the transfer-out user is added into the user blacklist to be issued to each first resource management client or resource transfer terminal, and the first resource management client or the resource transfer terminal is notified to refuse to perform resource transfer with the blacklist user, so as to reduce resource loss of the target merchant and the resource management platform.

According to the present embodiment, the resource transfer terminal pre-stores the user blacklist and indicates the first resource management client to set the user blacklist, the problem that the blacklist user cannot issue the user blacklist to the first resource management client without being connected to the network can be solved, so that a resource transfer risk is avoided, and the resource loss of the target merchant and the resource management platform is reduced. For example, after the user is connected to the network to log in the resource management platform, the network is disconnected, the multi-time offline resource transfer is performed through the resource transfer terminal, but the resource management platform cannot successfully complete resource transfer due to resource insufficiency in the account, and the target merchant may suffer greater loss if the user is not added to the user blacklist, and the user blacklist is not issued to the resource transfer terminal in time. By issuing the user blacklist to the resource transfer terminal by means of near field communication through the second resource management client, the blacklist user can be discovered under the condition that the user is not connected to the network, and the security of resource transfer is improved.

However, with the gradual increase of the blacklist users, the user blacklist may occupy a great storage space of the resource transfer terminal. In order to improve the utilization efficiency of resources stored in the resource transfer terminal, when the user reads the resource transfer terminal through the first resource management client, the resource transfer terminal determines whether the user is a user in the user blacklist or not according to the locally stored user blacklist. In response to that it is determined that the user is a user in the user blacklist, the resource transfer terminal sends the blacklist setting instruction by means of near field communication to notify the first resource management client to locally set the user into the blacklist user in the first resource management client. Then, the resource transfer terminal removes the user from the locally stored user blacklist in the resource transfer terminal, so as to save the storage space of the resource transfer terminal.

In some embodiments, before the resource transfer terminal accepts the resource transfer order with the signatures, the method further includes:

The resource transfer terminal performs encryption processing on the resource transfer order with the signatures through a preset key.

During specific implementation, a key issued by the built-in resource management platform of the resource transfer terminal is configured to manage the resource transfer terminal by the resource management platform. At the same time, the resource management platform further issues a data transmission key or a trading key to the resource transfer terminal according to application of the second resource management client, and the data transmission key or the trading key is sent by the second resource management client to the resource transfer terminal to be stored. Before the resource transfer terminal sends the resource transfer order to the first resource management client, or locally stores the resource transfer order, transmission and storage are performed after the order is encrypted through the preset trading key or the data transmission key, so as to improve the security of resource transfer.

The key is stored in the resource transfer terminal of the target merchant. Additionally, the resource management platform may update the key, and send the updated key to the resource transfer terminal. The resource transfer terminal updates the locally stored key into the received key to realize updating of the key at any time. Additionally, the resource transfer terminal, the first resource management client and the second resource management client do not have permission to resolve the key, and only the resource management platform controls the generation of the key and resolves the key, so that the security of resource transfer can be further improved.

### Embodiment 2

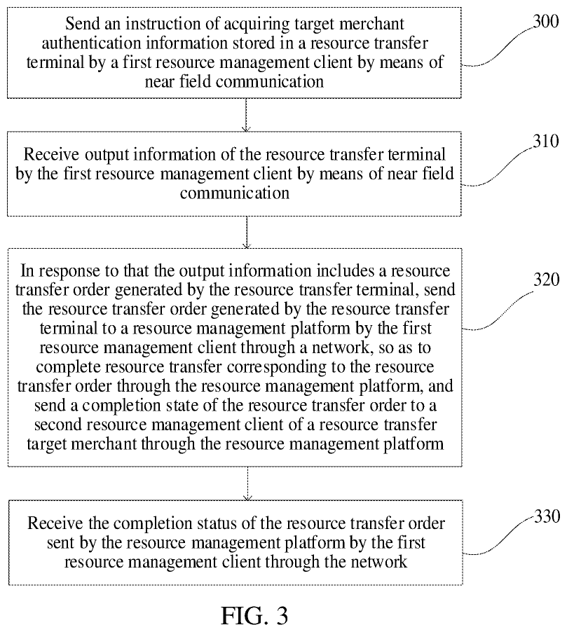

The present embodiment discloses a resource transfer method based on near field communication. As shown in FIG. 3, the method includes: step 300 to step 330.

Step 300, a first resource management client sends an instruction of acquiring target merchant authentication information stored in a resource transfer terminal by means of near field communication.

The first resource management client is an application client of a resource management platform. During specific application, in a possible implementation, the first resource management client is application software installed in equipment with a near field communication module, such as a mobile phone of a user. In another possible implementation, the first resource management client is user equipment with a near field communication module. In the present embodiment, the first resource management client is illustrated to be the application software installed in the equipment with the near field communication module, such as the mobile phone of the user, as an example.

In response to a condition that the user wants to transfer resources with a target merchant by means of near field communication, for example, the user wants to perform order payment to the merchant by means of near field communication, the user logs in the first resource management client installed in the mobile phone with a near field communication function, and then initiates a payment flow process. The first resource management client may transmit a signal for reading the resource transfer terminal through a near field communication module of a mobile phone. The signal carries a user identifier of a current login user and an instruction for acquiring the target merchant authentication information of the target merchant.

Step 310, the first resource management client receives output information of the resource transfer terminal by means of near field communication.

The resource transfer terminal includes a casing and a near field communication module. The resource transfer terminal is equipment of the target merchant. During specific implementation, the resource transfer terminal is optionally portable equipment with a built-in near field communication module, such as a card or a name plate. The resource transfer terminal is preset with a merchant signature of the target merchant and the target merchant authentication information. The target merchant authentication information is optionally a merchant name or an icon, etc. The merchant signature is a numeral string generated according to a merchant identifier of the target merchant. The merchant identifier is a unique identifier acquired by the target merchant through the resource management platform.

After sensing a near field communication signal for reading the resource transfer terminal, the near field communication module of the resource transfer terminal processes the received signal, and analyzes information sent by the first resource management client. Here, the resource transfer terminal analyzes s the user identifier of a current login user in the first resource management client, and an instruction of acquiring merchant authentication information (i.e., the target merchant authentication information) locally stored by the resource transfer terminal. The resource transfer terminal sends output information to the first resource management client according to the instruction. The output information at least includes the locally stored authentication information, i.e., the target merchant authentication information. The resource transfer terminal further includes a resource transfer order. At the same time, the resource transfer terminal stores the resolved user identifier, i.e., the user identifier of the current login user in the first resource management client for sending the information of reading the resource transfer terminal is stored.

Step 320, in response to that the output information includes a resource transfer order generated by the resource transfer terminal, the first resource management client sends the resource transfer order generated by the resource transfer terminal to the resource management platform through a network, so as to complete resource transfer corresponding to the resource transfer order through the resource management platform, and sends a completion state of the resource transfer order to a second resource management client of a resource transfer target merchant through the resource management platform.

During specific implementation, the target merchant optionally sends the quantity of resources transferred by a single order to the resource transfer terminal through the second resource management client to realize transfer of a fixed quantity of resources in a single time. In response to receiving the quantity of resources transferred by a single order sent by the second resource management client, the resource transfer terminal may locally store the quantity of resources transferred by a single order, and enables a fixed quantity resource transfer mode.

In response to that the user initiates a resource transfer flow process through the first resource management client, and moves close to the resource transfer terminal to read the authentication information of the resource transfer terminal, the first resource client sends a starting signal to the resource transfer terminal. The starting signal carries the user identifier of the current login user. The near field communication module of the resource transfer terminal starts at an induced voltage generated in response to an induced signal of the first resource management client, and extracts the user identifier carried in the starting signal sent by the first resource management client. At the same time, the resource transfer terminal judges whether the fixed quantity resource transfer mode is enabled. In response to determining that the fixed quantity resource transfer mode has been enabled, the resource transfer terminal generates the resource transfer order according to a locally prestored quantity of resources transferred by a single order. Then, a user signature is generated according to the user identifier. For example, a user signature of a resource transfer-out user is generated according to a user identifier of the resource transfer-out user, and the locally prestored merchant signature of the target merchant and the user signature of the resource transfer-out user are added to the resource transfer order. Finally, the resource transfer terminal outputs the resource transfer order with the signatures by means of near field communication.

After receiving the resource transfer order output by the resource transfer terminal, the first resource management client sends the resource transfer order generated by the resource transfer terminal to the resource management platform through the network, so as to complete resource transfer corresponding to the resource transfer order through the resource management platform. The resource management platform resolves and processes the received resource transfer order, completes transfer of the corresponding quantity of resources in the resource transfer order from the transfer-out user to the target merchant, and sends the completion state of the resource transfer order to the second resource management client of the resource transfer target merchant. The completion status includes a successful resource transfer state or a failed resource transfer state.

Step 330, the first resource management client receives the completion status of the resource transfer order sent by the resource management platform through the network.

After resource transfer is completed, the resource management platform sends the completion status of the resource transfer order (such as successful resource transfer or failed resource transfer) to the first resource management client of the resource transfer order through the network.

According to the resource transfer method based on near field communication disclosed by the present embodiment, the first resource management client sends the instruction of acquiring the target merchant authentication information stored in the resource transfer terminal by means of near field communication, and receives output information of the resource transfer terminal by means of near field communication. In response to that the output information includes the resource transfer order generated by the resource transfer terminal, the first resource management client sends the resource transfer order generated by the resource transfer terminal to the resource management platform through the network, so as to complete resource transfer corresponding to the resource transfer order through the resource management platform. Finally, the first resource management client receives the completion state of the resource transfer order sent by the resource management platform through the network. The problem of limited use scenario of the resource transfer method is solved. By using the resource transfer method disclosed by the present embodiment, the resource transfer terminal of the target merchant can complete resource transfer without being connected to the network, so that the user can initiate a resource transfer operation at any time in any place, and great convenience is provided for the resource transfer of the user. At the same time, the resource transfer terminal may only include the near field communication module, so that the equipment cost of the target merchant is reduced, and the popularization of a resource transfer system is better facilitated.

In some embodiments, the resource transfer order generated by the resource transfer terminal is an encrypted resource transfer order generated according to the user signature of the current login user of the first resource management client, the merchant signature of the target merchant and a preset key. The user signature is generated according to the user identifier carried in the instruction of acquiring the target merchant authentication information stored in the resource transfer terminal.

During specific implementation, a key issued by the built-in resource management platform of the resource transfer terminal is configured to manage the resource transfer terminal by the resource management platform. At the same time, the resource management platform further issues a data transmission key or a trading key to the resource transfer terminal according to application of the second resource management client, and the data transmission key or the trading key is sent by the second resource management client to the resource transfer terminal to be stored. When the resource transfer terminal sends the resource transfer order to the first resource management client, preferably, transmission and storage are performed after the order is encrypted through the preset trading key or the data transmission key, so as to improve the security of resource transfer.

The key is stored in the resource transfer terminal of the target merchant. The resource management platform may update the key, and send the updated key to the resource transfer terminal. The resource transfer terminal updates the locally stored key into the received key to realize updating of the key at any time. Additionally, the resource transfer terminal, the first resource management client and the second resource management client do not have permission to resolve the key, and only the resource management platform controls the generation of the key and resolves the key, so that the security of resource transfer can be further improved.

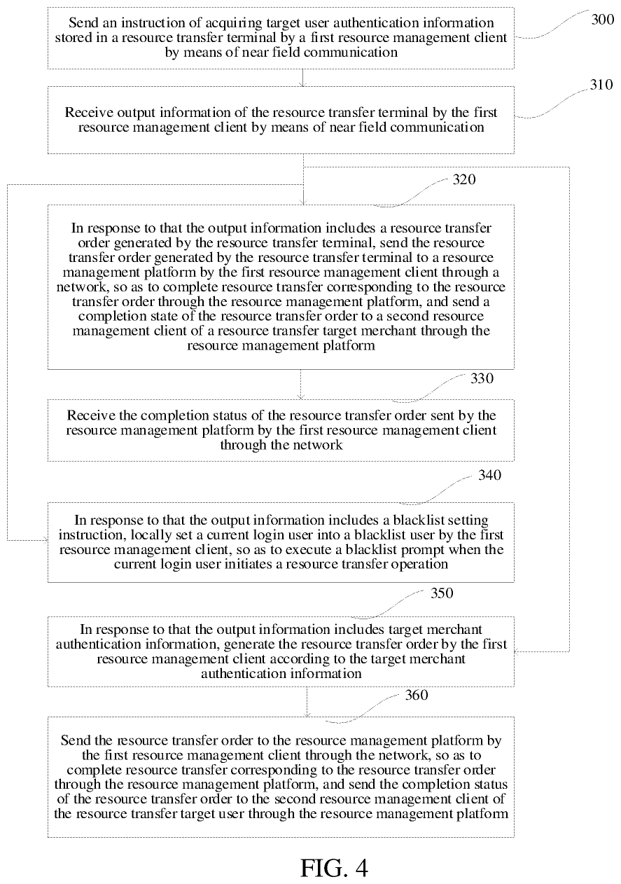

In some embodiments, in one modification of the present embodiment, as shown in FIG. 4, after the first resource management client sends the instruction of acquiring the target merchant authentication information stored in the resource transfer terminal to the resource transfer terminal by means of near field communication, the first resource management client receives output information of the resource transfer terminal by means of near field communication.

During specific implementation, the output information of the resource transfer terminal includes various conditions. According to different conditions, the first resource management client performs different operations.

Step 340, in response to that the output information includes a blacklist setting instruction, the first resource management client locally sets the current login user into a blacklist user, so as to execute a blacklist prompt when the current login user initiates the resource transfer operation.

During specific implementation, after successful acceptance of the offline resource transfer order, the second resource management client may read the resource transfer order in the resource transfer terminal after a period of time, and then settles accounts with the resource management platform to finally complete resource transfer. A condition that the resource quantity in the account of the resource transfer-out user is smaller than the quantity of to-be-transferred resources in the order may occur, so that the resource management platform cannot successfully complete the settlement between the transfer-out user and the target merchant. To address such issues, the resource transfer method of the present disclosure sets the user blacklist. When the number of times of settlement incapable of being successfully completed by the resource management platform on one transfer-out user exceeds a preset quantity, the transfer-out user is added into the user blacklist to be issued to each first resource management client or resource transfer terminal, and the first resource management client or the resource transfer terminal is notified to refuse to perform resource transfer with the blacklist user, so as to reduce resource loss of the target merchant and the resource management platform.

However, with the gradual increase of the blacklist users, the user blacklist may occupy a great storage space of the resource transfer terminal. In order to improve the utilization efficiency of resources stored in the resource transfer terminal, when the user reads the resource transfer terminal through the first resource management client, the resource transfer terminal determines whether the user identifier of the user is a user in the user blacklist according to the locally stored user blacklist. If it is determined that the user identifier is a user in the user blacklist, the blacklist setting instruction is sent by means of near field communication to notify the first resource management client to locally set the user into the blacklist user in the first resource management client. Then, the resource transfer terminal removes the user from the locally stored user blacklist in the resource transfer terminal, so as to save the storage space of the resource transfer terminal.

In response to that the first resource management client detects that the user initiates the resource transfer flow process, the first resource management client acquires the user identifier of the current login user, and matches the user identifier with the user identifier of the preset blacklist user. If the matching is successful, it is confirmed that the current login user is the blacklist user. Then, the first resource management client executes the blacklist prompt. For example, the user is prompted for the existence of resources not successfully transferred, or the user is prompted to be blacklisted, and the user is prompted to be removed from the blacklist through the resource management platform. If the matching fails, it is determined that the current login user is not the blacklist user. Step 360 is performed.

In some embodiments, during specific implementation, after the first resource management client receives the output information of the resource transfer terminal by means of near field communication, the method further includes:

Step 350, in response to that the output information includes the target merchant authentication information, the first resource management client generates the resource transfer order according to the target merchant authentication information.

In response to that the output information of the resource transfer terminal received by the first resource management client includes the target merchant authentication information, the first resource management client authenticates the target merchant authentication information, for example, information carried in the target merchant authentication information, such as a target merchant icon, is shown for the current login user to confirm. The target merchant authentication information further includes a target merchant identifier. Then, the first resource management client generates the resource transfer order according to the resource transfer quantity input by the user and an operation of confirming generation of the resource transfer order. The resource transfer order includes information such as a user tag of the current login user of the first resource management client, a merchant tag of the target merchant, and the resource transfer quantity. The merchant tag of the target merchant is generated according to the merchant identifier of the target merchant included in the output information.

Step 360, the first resource management client sends the resource transfer order to the resource management platform through the network, so as to complete resource transfer corresponding to the resource transfer order through the resource management platform, and sends the completion status of the resource transfer order to the second resource management client of the resource transfer target merchant through the resource management platform.

In an online state, the first resource management client sends the resource transfer order to the resource management platform through the network. After receiving the resource transfer order, the resource management platform resolves and processes the resource transfer order, extracts the user identifier of the resource transfer-out user, the merchant identifier of the target merchant and the resource transfer quantity in the order, then transfers resources of the resource transfer quantity from the account of the resource transfer-out user to the account of the target merchant according to the user identifier of the resource transfer-out user and the merchant identifier of the target merchant, and stores resource transfer information. After resource transfer is completed, the resource management platform sends the completion state of the resource transfer order to the second resource management client of the resource transfer target merchant.

### Embodiment 3

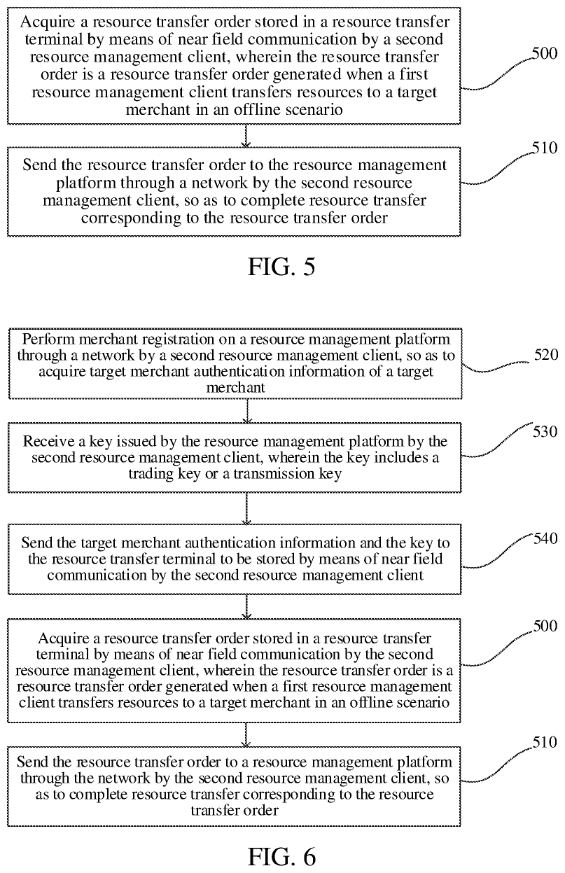

The present embodiment discloses a resource transfer method based on near field communication. As shown in FIG. 5, the method includes: step 500 to step 510.

Step 500, a second resource management client acquires a resource transfer order stored in a resource transfer terminal by means of near field communication. The resource transfer order is a resource transfer order generated when a first resource management client transfers resources to a target merchant in an offline scenario.

A second resource management client is an application client of the target merchant of the resource management platform. During specific application, in one embodiment, the second resource management client is application software installed in equipment with a near field communication module, such as a mobile phone of a target merchant. In another embodiment, the second resource management client is other equipment of the target merchant with a near field communication module. In the present embodiment, the second resource management client is illustrated to be the application software installed in the equipment with the near field communication module, such as the mobile phone of the target merchant, as an example.

In response to that a current login user of the first resource management client performs offline resource transfer with the target merchant by means of near field communication, an offline resource transfer order will be stored in the resource transfer terminal. During specific implementation, the second resource management client may read the resource transfer order stored in the resource transfer terminal in real time or in regular time or according to the triggering of the resource management platform.

During specific implementation, the second resource management client acquires the resource transfer order stored in the resource transfer terminal by means of near field communication. The second resource management client transmits a signal for reading the resource transfer order to the resource transfer terminal by means of near field communication. The resource transfer terminal starts to work under the effect of an induced voltage generated in response to a near field communication signal, and outputs the locally stored resource transfer order.

Step 510, the second resource management client sends the resource transfer order to the resource management platform through the network, so as to complete resource transfer corresponding to the resource transfer order.

After the second resource management client reads the resource transfer order stored in the resource transfer terminal by means of near field communication, the resource transfer order is uploaded to the resource management platform through the network, and the resource management platform resolves and processes the order, and further completes resource transfer corresponding to each resource transfer order. Finally, the second resource management client receives a completion state of the resource transfer order fed back by the resource management platform.

The network may include at least one of a 4^{th} generation (4G) network, a 5^{th} generation (5G) network and a wireless fidelity (WiFi) network.

According to the resource transfer method based on near field communication disclosed by the present embodiment, the offline resource transfer order stored in the resource transfer terminal is acquired by means of near field communication. Then, the resource transfer order is sent to the resource management platform through the network, so as to complete resource transfer corresponding to the resource transfer order. The problem of limited use scenario of the resource transfer method is solved. According to the resource transfer method based on near field communication disclosed by the present embodiment, when the user is not connected to the network, the resource transfer order is determined by means of near field communication, and the offline resource transfer order is stored in the resource transfer terminal. Then, the second resource management client uploads the offline resource transfer order to the resource management platform to complete resource transfer, so that the user can complete resource transfer without being connected to the network. The use scenarios of the resource transfer method are increased, convenience is provided for resource transfer, and the popularization and application of the resource transfer method based on near field communication are facilitated.

In some embodiments, as shown in FIG. 6, in one modification of the embodiment, before the resource transfer order stored in the resource transfer terminal is acquired by means of near field communication, the method further includes:

Step 520, the second resource management client performs merchant registration on the resource management platform through the network, so as to acquire target merchant authentication information of the target merchant.

Firstly, the target merchant (i.e., a merchant receiving a transfer-in resource) is registered on the resource management platform through the second resource management client, and acquires a merchant identifier of the target merchant and the target merchant authentication information of the target merchant.

Step 530, the second resource management client receives a key issued by the resource management platform. The key includes a trading key or a transmission key.

During specific implementation, the resource management platform may further issue the key to the registered target merchant to perform encrypted storage and/or encrypted transmission of the resource transfer order. During specific implementation, in one embodiment, the resource management platform actively issues the key to the successfully registered target merchant. In another embodiment, the resource management platform issues the key in real time according to application of the target merchant. In response to that the resource management platform issues the key in real time according to the application of the target merchant, before this step, the second resource management client sends a key acquiring request to the resource management platform. The resource management platform issues the key to the second resource management client according to the key acquiring request.

Step 540, the second resource management client sends the target merchant authentication information and the key to the resource transfer terminal to be stored by means of near field communication.

After receiving the target merchant authentication information and the key issued by the resource management platform, the second resource management client transmits a near field communication signal for writing in data (the target merchant authentication information and the key) to the resource transfer terminal. The near field communication signal carries a write-in instruction. The resource transfer terminal starts to work under the triggering of an induced voltage generated in response to the near field communication signal, and stores the target merchant authentication information and the key according to a write-in instruction of the second resource management client.

It should be noted that, in some embodiments, the target merchant authentication information and the key are written in the resource transfer terminal through a write-in instruction request. In some embodiments, the target merchant authentication information and the key are written in the resource transfer terminal through two write-in instruction requests. Correspondingly, the process includes: after receiving the target merchant authentication information issued by the resource management platform, the second resource management client transmits a first near field communication signal for writing in data (the target merchant authentication information) to the resource transfer terminal, and the first near field communication signal carries a first write-in instruction. The resource transfer terminal starts to work under the effect of an induced voltage generated in response to the first near field communication signal, and stores the target merchant authentication information according to the first write-in instruction of the second resource management client.

After receiving the key issued by the resource management platform, the second resource management client transmits a second near field communication signal for writing in data (the key) to the resource transfer terminal, and the second near field communication signal carries a second write-in instruction. The resource transfer terminal starts to work under the effect of an induced voltage generated in response to the second near field communication signal, and stores the key according to the second write-in instruction of the second resource management client.

In some embodiments, the resource transfer order is an encrypted order subjected to encryption processing through a preset key in the resource transfer terminal.

In response to that the current login user of the first resource management client performs offline resource transfer to the resource transfer terminal by means of near field communication, the resource transfer terminal generates the resource transfer order and performs encryption processing on the resource transfer order through the preset key, and then locally stores the encrypted order. During specific implementation, in response to that the second resource management client reads the resource transfer order, the resource transfer terminal further encrypts the resource transfer order through the transmission key, and sends the encrypted resource transfer order to the second resource management client, so as to improve security of resource transfer.

In some embodiments, after the target merchant authentication information and the key are sent to the resource transfer terminal to be stored by means of near field communication, the method further includes: a resource transfer function is enabled on the resource management platform through the network, so that the resource management platform completes resource transfer corresponding to the resource transfer order according to the resource transfer order sent by the first resource management client and the resource transfer order sent by the second resource management client. During specific implementation, the second resource management client makes an application to the resource management platform to enable a resource transfer function of the resource management client through the network. Then, the resource management platform may generate a unique trading key and/or a payment key for the target merchant according to the merchant identifier of the target merchant sent by the second resource management client, and feeds the trading key and/or the payment key to the second resource management client through the network. The second resource management client sends the trading key and/or the payment key to the resource transfer terminal by means of near field communication. The trading key and/or the payment key are/is transmitted through the second resource management client, and are/is configured to encrypt data indirectly transmitted between the resource transfer terminal and the resource management platform. The transmission security of the resource transfer order can be further improved.

### Embodiment 4

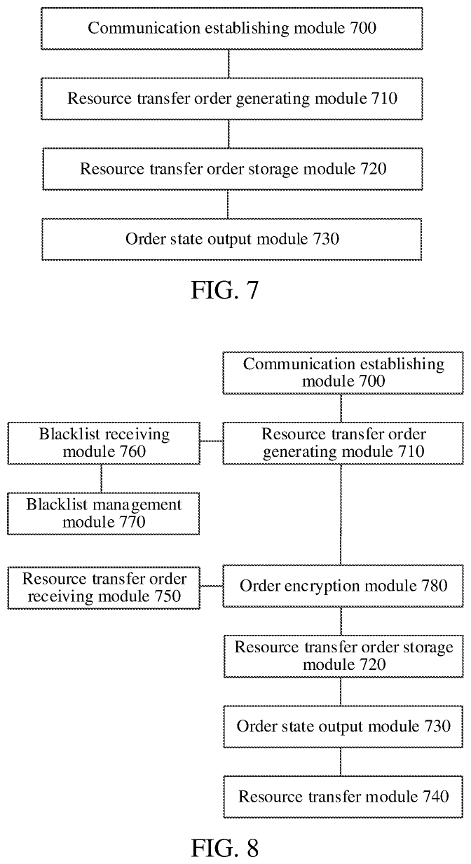

The present embodiment discloses a resource transfer device based on near field communication. As shown in FIG. 7, the device includes:

a communication establishing module 700, configured to acquire a user identifier of a current login user in a first resource management client according to the triggering of the first resource management client;

a resource transfer order generating module 710, configured to generate a resource transfer order according to a preset quantity of resources transferred by a single order in response to determining that a resource transfer terminal has enabled a fixed quantity resource transfer mode;

a resource transfer order storage module 720, configured to add a merchant signature of a target merchant and a user signature generated according to the acquired user identifier to the resource transfer order, and store the resource transfer order with the signatures; and an order state output module 730, configured to send an acceptance state of the resource transfer order with the signatures to the first resource management client by means of near field communication.

The fixed quantity resource transfer mode and the quantity of resources transferred by each order are set according to data sent by a second resource management client.

In some embodiments, as shown in FIG. 8, the device further includes:

a resource transfer module 740, configured to output the stored resource transfer order according to the triggering of the second resource management client, so that the second resource management client completes resource transfer corresponding to the resource transfer order through a resource management platform.

Taking code scanning payment as an example, a user needs to be connected to a network to perform code scanning payment, so that the application scenario is limited. By using a resource transfer method based on near field communication disclosed by the embodiments of the disclosure, offline resource transfer can be realized by using the resource transfer terminal as a medium. The problem that resource transfer can only be completed under the network connected condition by a resource transfer-out user and a resource transfer-in user is solved, convenience is provided for the resource transfer of the users, and the application scenarios of resource transfer are expanded. Additionally, the resource transfer terminal is used as the medium, resource transfer is performed by means of near field communication, and the security is higher.

In some embodiments, as shown in FIG. 8, the device further includes:

a resource transfer order receiving module 750, configured to receive the resource transfer order sent by the first resource management client by means of near field communication;

the resource transfer order storage module 720, configured to add the target merchant signature and the user signature generated according to the user identifier to the received resource transfer order sent by the first resource management client by means of near field communication, and store the resource transfer order with the signatures; and

the order state output module 730, configured to send the acceptance state of the resource transfer order to the first resource management client by means of near field communication after the resource transfer order storage module 720 locally stores the resource transfer order with the signatures.

In some embodiments, as shown in FIG. 8, the device further includes:

a blacklist receiving module 760, configured to receive a user blacklist sent by the second resource management client by means of near field communication, and store the user blacklist; and

a blacklist management module 770, configured to send a blacklist setting instruction of setting a user into a blacklist user to the first resource management client by means of near field communication when it is determined that the user identifier corresponds to a user in the blacklist based on the user blacklist, and remove the user from the user blacklist.

According to the present embodiment, the blacklist of the first resource management client is set through the resource transfer terminal. The problem that the blacklist user cannot issue the user blacklist to the first resource management client without being connected to the network can be solved, so that a resource transfer risk is avoided, and the resource loss of the target merchant and the resource management platform is reduced. For example, after the user is connected to the network to log in the resource management platform, the network is disconnected, the multi-time offline resource transfer is performed through the resource transfer terminal, but the resource management platform cannot successfully complete resource transfer due to resource insufficiency in the account, and the target merchant may suffer greater loss if the user is not added to the user blacklist, and the user blacklist is not issued to the resource transfer terminal in time. By issuing the user blacklist to the resource transfer terminal by means of near field communication through the second resource management client, the blacklist user can be discovered under the condition that the user is not connected to the network, and the security of resource transfer is improved.

However, with the gradual increase of the blacklist users, the user blacklist may occupy a great storage space of the resource transfer terminal. In order to improve the utilization efficiency of resources stored in the resource transfer terminal, when the user reads the resource transfer terminal through the first resource management client, the resource transfer terminal determines whether the user identifier of the user is a user in the user blacklist or not according to the locally stored user blacklist. If it is determined that the user identifier is a user in the user blacklist, the blacklist setting instruction is sent by means of near field communication to notify the first resource management client to locally set the user into the blacklist user in the first resource management client. Then, the resource transfer terminal removes the user from the locally stored user blacklist in the resource transfer terminal, so as to save the storage space of the resource transfer terminal.

In some embodiments, as shown in FIG. 8, the device further includes an order encryption module 780, configured to perform encryption processing on the resource transfer order with the user signature through a preset key.

During specific implementation, a root key issued by the built-in resource management platform of the resource transfer terminal is configured to manage the resource transfer terminal by the resource management platform. At the same time, the resource management platform further issues a data transmission key or a trading key to the resource transfer terminal according to application of the second resource management client, and the data transmission key or the trading key is sent by the second resource management client to the resource transfer terminal to be stored. When the resource transfer terminal sends the resource transfer order to the first resource management client, or locally stores the resource transfer order, preferably, transmission and storage are performed after the order is encrypted through the preset trading key or the data transmission key, so as to improve the security of resource transfer.

The key is stored in the resource transfer terminal of the target merchant, and can be updated at any time. Additionally, the resource transfer terminal, the first resource management client and the second resource management client do not have permission to resolve the key, and only the resource management platform controls the generation of the key and resolves the key, so that the security of resource transfer can be further improved.

For specific implementations of each module, reference is made to the above embodiment, and the descriptions thereof are omitted herein.

According to the resource transfer device based on near field communication disclosed by the embodiment of the disclosure, the user identifier of the current login user in the first resource management client is acquired according to the triggering of the first resource management client, and the target merchant authentication information is output. Then, the resource transfer order sent by the first resource management client by means of near field communication is received. The user signature and the merchant signature are added to the resource transfer order, and then the resource transfer order with the signatures is stored. The problems of limited use scenario and high cost of the resource transfer method are solved. According to the resource transfer device based on near field communication disclosed by the embodiment of the disclosure, resource transfer can be completed by means of near field communication under the condition that a near field communication terminal of the user is not connected to the network. At the same time, the resource transfer terminal does not need to be connected to the network, and the use scenario is not limited. Additionally, a host of the first resource management client in the disclosure may be a mobile phone with a near field communication function. The resource transfer terminal only needs to include a field communication module, for example, may be an electronic card with the near field communication module. The cost is very low. Wide application is facilitated. The near field communication module can realize self-power supply after sensing a radio frequency signal, additionally, a certain storage space exists in the near field communication module, and a control program can be developed on an embedded secure element included in the near field communication module. Therefore, the resource transfer terminal can complete reception and storage of the resource transfer order and complete offline resource transfer.

### Embodiment 5

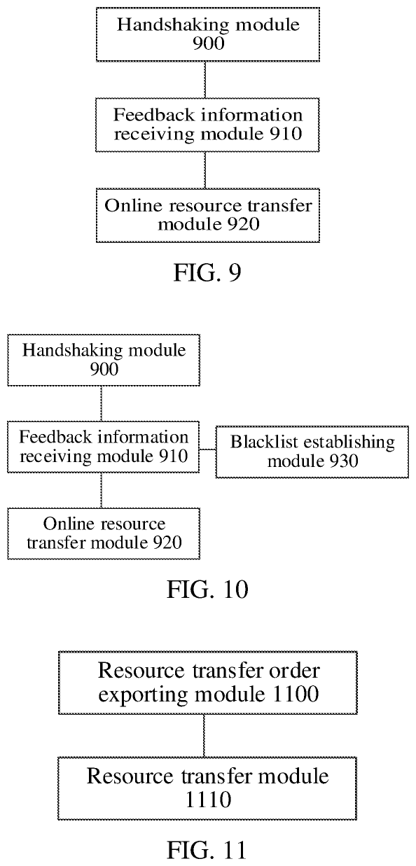

The present embodiment discloses a resource transfer device based on near field communication. As shown in FIG. 9, the device includes:

a handshaking module 900, configured to send an instruction of acquiring target merchant authentication information stored in a resource transfer terminal by means of near field communication;

a feedback information receiving module 910, configured to receive output information of the resource transfer terminal by means of near field communication; and

an online resource transfer module 920, configured to send a resource transfer order to a resource management platform through a network in response to that the output information includes the resource transfer order generated by the resource transfer terminal, so as to complete resource transfer corresponding to the resource transfer order through the resource management platform, and send a completion state of the resource transfer order to the resource transfer terminal through the resource management platform.

According to the resource transfer device based on near field communication disclosed by the present embodiment, the instruction of acquiring the target merchant authentication information stored in the resource transfer terminal is sent by means of near field communication, and the output information of the resource transfer terminal is received by means of near field communication. When the output information includes the resource transfer order generated by the resource transfer terminal, a first resource management client sends the resource transfer order generated by the resource transfer terminal to the resource management platform through the network, so as to complete resource transfer corresponding to the resource transfer order through the resource management platform. Finally, the first resource management client receives the completion state of the resource transfer order sent by the resource management platform through the network. The problem of limited use scenario of the resource transfer device is solved. By using the resource transfer device disclosed by the present embodiment, the resource transfer terminal of the target merchant can complete the resource transfer without being connected to the network, so that the user can initiate a resource transfer operation at any time in any place, and great convenience is provided for resource transfer. At the same time, the resource transfer terminal only needs to include a near field communication module, so that the equipment cost of the target merchant is reduced, and the popularization of a resource transfer system is better facilitated.

In some embodiments, the resource transfer order generated by the resource transfer terminal is an encrypted resource transfer order generated according to a user signature of a current login user of the first resource management client, a merchant signature of the target merchant and a preset key. The user signature is generated according to a user identifier carried in the instruction of acquiring the target merchant authentication information stored in the resource transfer terminal.

During specific implementation, a root key issued by the built-in resource management platform of the resource transfer terminal is configured to manage the resource transfer terminal by the resource management platform. At the same time, the resource management platform further issues a data transmission key or a trading key to the resource transfer terminal according to application of a second resource management client, and the data transmission key or the trading key is sent by the second resource management client to the resource transfer terminal to be stored. When the resource transfer terminal sends the resource transfer order to the first resource management client, preferably, transmission and storage are performed after the order is encrypted through the preset trading key or the data transmission key, so as to improve the security of resource transfer.

The key is stored in the resource transfer terminal of the target merchant, and can be updated at any time. Additionally, the resource transfer terminal, the first resource management client and the second resource management client do not have permission to resolve the key, and only the resource management platform controls the generation of the key and resolves the key, so that the security of resource transfer can be further improved.

In some embodiments, as shown in FIG. 10, the device further includes: a blacklist establishing module 930, configured to locally set the current login user into a blacklist user in the first resource management client in response to that the output information includes a blacklist setting instruction, so as to execute a blacklist prompt when the current login user initiates the resource transfer operation.

During specific implementation, after successful acceptance of the offline resource transfer order, the second resource management client may read the resource transfer order in the resource transfer terminal after a period of time, and then settles accounts with the resource management platform to finally complete resource transfer. A condition that the resource quantity in the account of the resource transfer-out user is smaller than the quantity of to-be-transferred resources in the order may occur, so that the resource management platform cannot successfully complete the settlement between the transfer-out user and the target merchant. By aiming at this condition, the resource transfer method of the disclosure sets the user blacklist. When the number of times of settlement incapable of being successfully completed by the resource management platform on one transfer-out user exceeds a preset quantity, the transfer-out user is added into the user blacklist to be issued to each first resource management client or resource transfer terminal, and the first resource management client or the resource transfer terminal is notified to refuse to perform resource transfer with the blacklist user, so as to reduce resource loss of the target merchant and the resource management platform.

However, with the gradual increase of the blacklist users, the user blacklist may occupy a great storage space of the resource transfer terminal. In order to improve the utilization efficiency of resources stored in the resource transfer terminal, when the user reads the resource transfer terminal through the first resource management client, the resource transfer terminal determines whether the user identifier of the user is a user in the user blacklist or not according to the locally stored user blacklist. If it is determined that the user identifier is a user in the user blacklist, the blacklist setting instruction is sent by means of near field communication to notify the first resource management client to locally set the user into the blacklist user in the first resource management client. Then, the resource transfer terminal removes the user from the locally stored user blacklist in the resource transfer terminal, so as to save the storage space of the resource transfer terminal.

When the first resource management client detects that the user initiates a resource transfer flow process, the first resource management client acquires the user identifier of the current login user, and matches the user identifier with the user identifier of the preset blacklist user. If the matching is successful, it is confirmed that the current login user is the blacklist user. Then, the first resource management client executes the blacklist prompt. For example, the user is prompted for the existence of resources not successfully transferred, or the user is prompted to be blacklisted, and the user is prompted to be in contact with the blacklist through the resource management platform.

In some embodiments, during specific implementation, after the first resource management client receives the output information of the resource transfer terminal by means of near field communication, the method further includes: when the output information includes the target merchant authentication information, the first resource management client generates the resource transfer order according to the target merchant authentication information.

When the output information of the second resource transfer terminal received by the first resource management client includes the target merchant authentication information, the first resource management client authenticates the authentication information, for example, information carried in the authentication information, such as a target merchant icon, is shown for the current login user to confirm. The target merchant authentication information further includes a target merchant identifier. Then, the first resource management client generates the resource transfer order according to the resource transfer quantity input by the user and an operation of confirming generation of the resource transfer order. The resource transfer order includes information such as a user tag of the current login user of the first resource management client, a merchant tag of the target merchant, and the resource transfer quantity. The merchant tag of the target merchant is generated according to the merchant identifier of the target merchant included in the output information.

The first resource management client sends the resource transfer order to the resource management platform through the network, so as to complete resource transfer corresponding to the resource transfer order through the resource management platform, and sends the completion state of the resource transfer order to the second resource management client of the resource transfer target merchant through the resource management platform.

In an online state, the first resource management client sends the resource transfer order to the resource management platform through the network. After receiving the resource transfer order, the resource management platform resolves and processes the order, extracts the resource transfer-out user, the target merchant and the resource transfer quantity in the order, then transfers a corresponding quantity of resources from the account of the resource transfer-out user to the account of the target merchant, and stores resource transfer information. After resource transfer is completed, the resource management platform sends the completion state of the resource transfer order to the second resource management client of the resource transfer target merchant.

### Embodiment 6

The present embodiment discloses a resource transfer device based on near field communication. As shown in FIG. 11, the device includes:

a resource transfer order exporting module 1100, configured to acquire a resource transfer order stored in a resource transfer terminal, where the resource transfer order is a resource transfer order generated when a first resource management client transfer resources to a target merchant in an offline scenario; and

a resource transfer module 1110, configured to send the resource transfer order to a resource management platform through a network, so as to complete resource transfer corresponding to the resource transfer order.

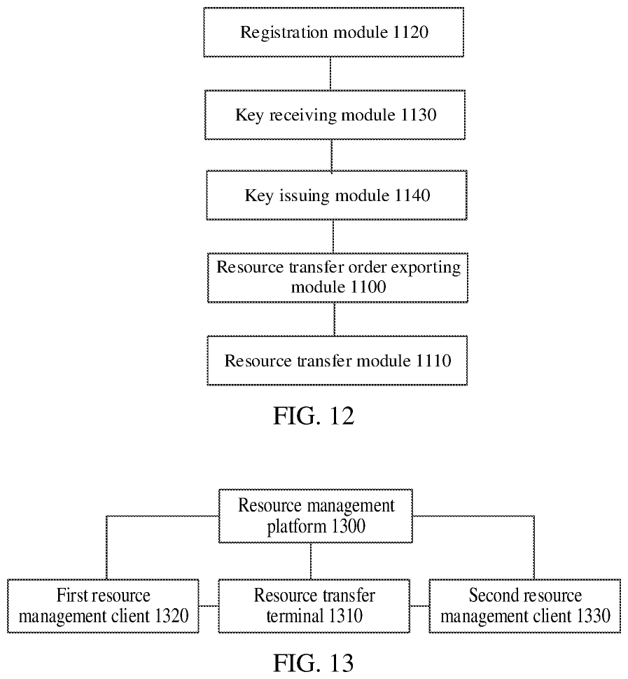

In some embodiments, as shown in FIG. 12, the device further includes:

a registration module 1120, configured to perform user registration on the resource management platform through the network, so as to acquire target merchant authentication information;

a key receiving module 1130, configured to receive a key issued by the resource management platform, where the key includes a trading key or a transmission key; and

a key issuing module 1140, configured to send the target merchant authentication information and the key to the resource transfer terminal to be stored by means of near field communication.

In some embodiments, the resource transfer order is an encrypted order subjected to encryption processing through a preset key in the resource transfer terminal.

When a current login user of the first resource management client performs offline resource transfer to the resource transfer terminal by means of near field communication, the resource transfer terminal generates the resource transfer order and performs encryption processing on the resource transfer order through the prestored key, and then locally stores the encrypted order. During specific implementation, when a second resource management client reads the resource transfer order, the resource transfer terminal can further encrypt the resource transfer order through the transmission key, so as to improve security of resource transfer.

In some embodiments, in another modification of the embodiment, the registration module 1120 is further configured to enable a resource transfer function on the resource management platform through a network, so that the resource management platform completes resource transfer corresponding to the resource transfer order according to the resource transfer order sent by the first resource management client or the resource transfer order sent by the second resource management client.

During specific implementation, the second resource management client makes an application to the resource management platform to enable a resource transfer function of the resource management client through the network. Then, the resource management platform may generate a unique trading key and/or a payment key for the target merchant according to a merchant identifier of the target merchant sent by the second resource management client, and feeds the trading key and/or the payment key to the second resource management client through the network. The second resource management client sends the key to the resource transfer terminal by means of the near field communication. The key is transmitted through the second resource management client, and is configured to encrypt data indirectly transmitted between the resource transfer terminal and the resource management platform. The transmission security of the resource transfer order can be further improved.

According to the resource transfer device based on near field communication disclosed by the present embodiment, the offline resource transfer order stored in the resource transfer terminal is acquired by means of near field communication. Then, the resource transfer order is sent to the resource management platform through the network, so as to complete resource transfer corresponding to the resource transfer order. The problem of limited use scenario of the resource transfer method is solved. According to the resource transfer device based on near field communication disclosed by the disclosure, when the user is not connected to the network, the resource transfer order is determined by means of near field communication, and the offline resource transfer order is stored in the resource transfer terminal. Then, the second resource management client uploads the offline resource transfer order to the resource management platform to complete resource transfer, so that the user can complete resource transfer without being connected to the network. In this way, the resource transfer method can be used in many environments, convenient for resource transfer, and the application of the resource transfer method based on near field communication are facilitated.

### Embodiment 7

The present embodiment discloses a resource transfer system based on near field communication. As shown in FIG. 13, the resource transfer system includes: a resource management platform 1300, a resource transfer terminal 1310, and a first resource management client 1320 and a second resource management client 1330 respectively communicated with the resource management platform through a network.

The resource management platform 1300 is configured to manage the resource transfer terminal 1310 and complete resource transfer of a resource transfer order.

The resource transfer terminal 1310 is configured to perform the resource transfer method based on near field communication according to Embodiment 1.

The first resource management client 1320 is configured to perform the resource transfer method based on near field communication according to Embodiment 2.

The second resource management client 1330 is configured to perform the resource transfer method based on near field communication according to Embodiment 3.

The resource transfer terminal 1310 is pre-authenticated and issued by the resource management platform 1300. The first resource management client 1320 and the second resource management client 1330 are optionally hardware equipment with a near field communication module pre-authenticated and issued by the resource management platform 1300, or an application program installed in hardware equipment with a near field communication module.

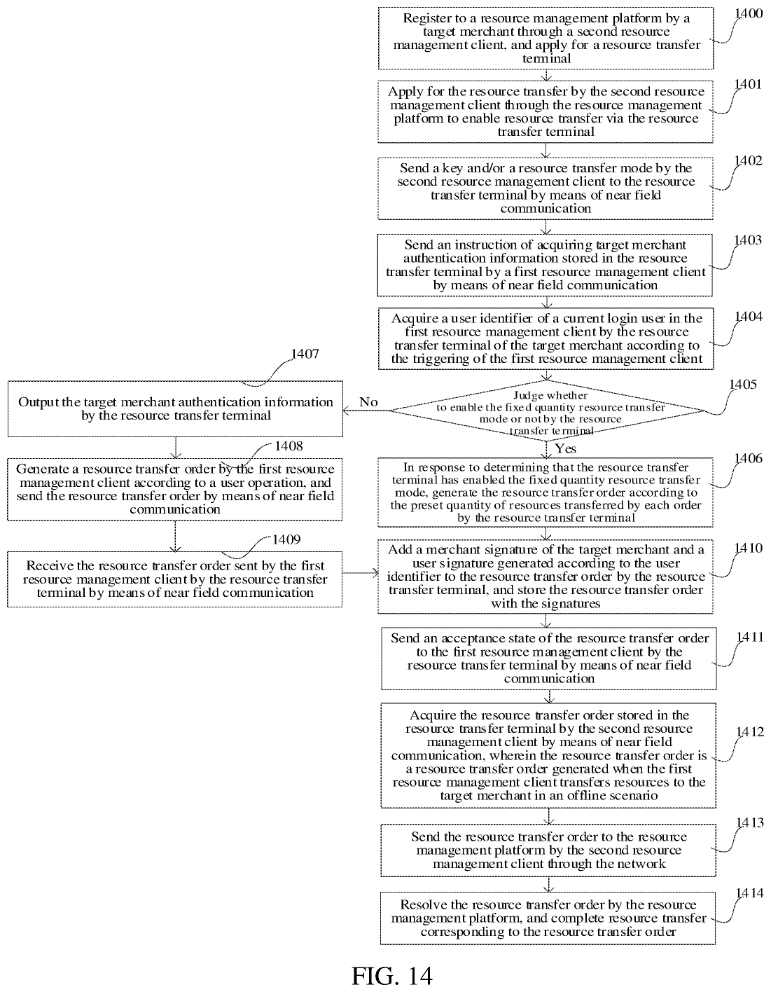

An offline resource transfer flow process of the resource transfer system based on near field communication disclosed by the embodiment of the disclosure is illustrated by examples in conjunction with FIG. 14.

Step 1400, a target merchant is registered to the resource management platform through the second resource management client, and applies for the resource transfer terminal.

During specific implementation, the target merchant may be a merchant. After the second resource management client of the target merchant completes registration on the resource management platform, the resource management platform will issue the resource transfer terminal to the successfully registered second resource management client. The resource transfer terminal may be preset with a verification key configured to manage the resource transfer terminal by the resource management platform, or configured to perform equipment verification on the resource transfer terminal by the first resource management client and the second resource management client.

During specific implementation, when the second resource management client registers on the resource management platform, self-related merchant information needs to be uploaded, such as a merchant name, resource receiving account information or an icon. The resource management platform generates a key according to the merchant information uploaded by the second resource management client. The key includes a trading key and/or a transmission key, and is sent to the second resource management client, and the second resource management client sends the key generated by the resource management platform to the resource transfer terminal to be stored.

Step 1401, the second resource management client applies for the resource transfer through the resource management platform to enable resource transfer via the resource transfer terminal.

The second resource management client sends a request of applying for opening the resource management client to enable resource transfer through the network, and at the same time, the second resource management client can further apply for enabling online resource transfer and offline resource transfer.

Step 1402, the second resource management client sends the key and/or a resource transfer mode to the resource transfer terminal by means of near field communication.

During specific implementation, the second resource management client sends resource transfer-related information issued by the resource transfer platform to the resource transfer terminal and to be stored by means of near field communication. The resource transfer-related information includes, but is not limited to, any one of the following: the key, the quantity transferred by each order, and the resource transfer mode.

Step 1403, the first resource management client sends an instruction of acquiring target merchant authentication information stored in the resource transfer terminal by means of near field communication.

During specific implementation, the first resource management client may be client software installed in a mobile phone of the user with the near field communication module. When performing resource transfer by reading the resource transfer terminal, the first resource management client needs to firstly register on the resource management platform, and acquires a unique user identifier sent by the resource management platform to the first resource management client.

Then, the first resource management client sends the instruction of acquiring the target merchant authentication information stored in the resource transfer terminal by means of near field communication. During specific implementation, the instruction of acquiring the target merchant authentication information stored in the resource transfer terminal includes a user identifier. Additionally or alternatively, the instruction of acquiring the target merchant authentication information stored in the resource transfer terminal further includes information about whether the first resource management client is online or not.

Step 1404, the resource transfer terminal of the target merchant acquires the user identifier of a current login user in the first resource management client according to the triggering of the first resource management client.

Step 1405, the resource transfer terminal judges whether to enable a fixed quantity resource transfer mode or not. If YES, step 1406 is performed. Otherwise, step 1407 is performed.

Step 1406, in response to determining that the resource transfer terminal has enabled the fixed quantity resource transfer mode, the resource transfer terminal generates the resource transfer order according to the preset quantity of resources transferred by each order.

When it is determined that the resource transfer terminal has enabled the fixed quantity resource transfer mode, the resource transfer terminal generates the resource transfer order according to the preset quantity of resources transferred by each order. Then, the flow jumps to step 1410, a merchant signature of the target merchant and a user signature generated according to the user identifier are added to the generated resource transfer order, and the resource transfer order is locally stored in the resource transfer terminal.

Step 1407, the resource transfer terminal outputs the target merchant authentication information.

Step 1408, the first resource management client generates the resource transfer order according to a user operation, and sends the resource transfer order by means of near field communication.

Step 1409, the resource transfer terminal receives the resource transfer order sent by the first resource management client by means of near field communication.

Step 1410, the resource transfer terminal adds the merchant signature of the target merchant and the user signature generated according to the user identifier to the resource transfer order, and stores the resource transfer order with the signatures.

Step 1411, the resource transfer terminal sends an acceptance state of the resource transfer order to the first resource management client by means of near field communication.

Hereto, the user completes offline resource transfer once with the target merchant through a terminal with a built-in near field communication module.

Step 1412, the second resource management client acquires the resource transfer order stored in the resource transfer terminal by means of near field communication, and the resource transfer order is a resource transfer order generated when the first resource management client transfers resources to the target merchant in an offline scenario.

Step 1413, the second resource management client sends the resource transfer order to the resource management platform through the network.

Step 1414, the resource management platform resolves the resource transfer order, and completes resource transfer corresponding to the resource transfer order.

The resource management platform decrypts the received resource transfer order according to the key applied by the second resource management client, resolves the resource transfer order, determines a resource transfer-out user, the target merchant and a resource transfer quantity, and finally transfers the resources of the resource transfer quantity from the account of the resource transfer-out user to the account of the target merchant.

During specific implementation, the resource transfer system based on near field communication disclosed by the embodiment of the disclosure can further realize online transfer of resources. For example, after the step that the resource transfer terminal of the target merchant acquires the user identifier of the current login user in the first resource management client according to the triggering of the first resource management client, if the resource transfer terminal judges that the first resource management client is online, and the resource transfer terminal enables the fixed quantity resource transfer mode, the resource transfer terminal generates encrypted order information and outputs the encrypted order information to the first resource management client. The encrypted order information is transmitted to the resource management platform by the first resource management client, so as to complete a fixed quantity of resource transfer. If the resource transfer terminal judges that the first resource management client is online, and the resource transfer terminal does not enable the fixed quantity resource transfer mode, the resource transfer terminal outputs the target merchant authentication information and the target merchant identifier to the first resource management client, and the resource transfer order is generated by the first resource management client according to input of the user, and is sent to the resource management platform, so as to complete the specified quantity of resource transfer.

During specific implementation of the disclosure, when the first resource management client reads the target merchant authentication information stored in the resource transfer terminal, the offline or online state information of the first resource management client can be simultaneously sent to the resource transfer terminal, so that the resource transfer terminal determines output data aiming at the first resource management client.

Correspondingly, the disclosure further discloses electronic equipment, including a storage medium, a processor and a machine executable instruction stored in the storage medium and capable of running on the processor. When the processor executes the machine executable instruction, the resource transfer method based on near field communication according to Embodiment 1 to Embodiment 3 of the disclosure is implemented. The electronic equipment may be a PC machine, a mobile terminal, a personal digital assistant, a tablet computer and the like.

The disclosure further discloses a computer readable storage medium. A computer program is stored thereon. When the program is executed by the processor, steps of the resource transfer method based on near field communication according to Embodiment 1 to Embodiment 3 of the disclosure are implemented.

### Embodiment 8

In the above description aiming at Embodiment 1 to Embodiment 7, the offline resource transfer order is stored in the resource transfer terminal. Besides information such as the user signature of the resource transfer-out user, the merchant signature of the resource transfer-in target merchant, the order time and the order content, the offline resource transfer order further includes a geographic position of a user requesting for resource transfer. In the present embodiment, a method of managing the position information of the target merchant by using the geographic position information in the resource transfer order is described in the present embodiment.

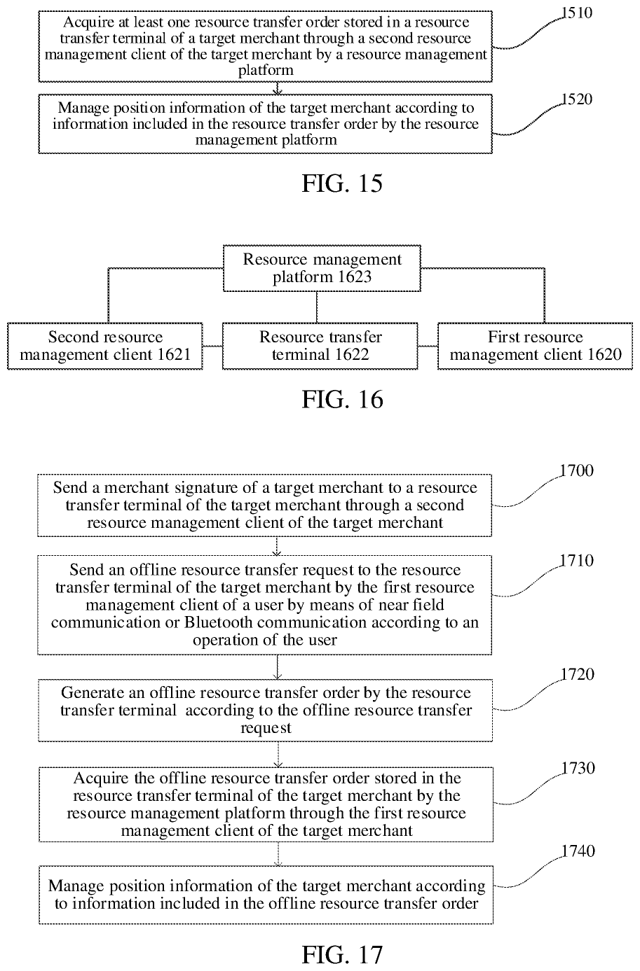

The present embodiment discloses a target merchant position information management method. As shown in FIG. 15, the method includes step 1510 to step 1520.

Step 1510, the resource management platform acquires at least one resource transfer order stored in a resource transfer terminal of a target merchant through a second resource management client of the target merchant.

During specific implementation, the second resource management client of the target merchant is a trading management client of the merchant. In one embodiment, a resource management platform sends settlement notification to the second resource management client of the target merchant or acquires an instruction of acquiring offline geographic position information of the merchant resource transfer terminal through a network, so as to request to acquire an offline resource transfer order of the target merchant. In another embodiment, the target merchant actively reads the offline resource transfer order in the resource transfer terminal through the second resource management client, and uploads the offline resource transfer order to the resource management platform through a network.

The offline resource transfer order stored in the resource transfer terminal is generated by the resource transfer terminal according to a resource transfer request sent by a user by means of near field communication or Bluetooth communication, or is received by means of near field communication or Bluetooth communication and generated by a first resource management client.

Step 1520, the resource management platform manages the position information of the target merchant according to information included in the resource transfer order.

The offline resource transfer order includes information such as the user signature of the resource transfer-out user, the merchant signature of the resource transfer-in target merchant, the order time and the order content. The offline resource transfer order further includes the geographic position of the user requesting for resource transfer.

In response to a condition of acquiring the resource transfer order stored in the resource transfer terminal, the resource management platform acquires the user signature of the transfer-out user and the merchant signature of the target merchant of each resource transfer order, and the geographic position by analyzing the resource transfer order. Then, the resource management platform uses the geographic position in each resource transfer order as the offline geographic position of the target merchant of the corresponding source transfer order. During specific implementation, the resource transfer order further includes the time of generating the resource transfer order, i.e., the time of the target merchant in the offline geographic position. The resource management platform manages the geographic position information of the target merchant according to each offline geographic position of the target merchant and the time in the offline geographic position. For example, a conventional moving route of the target merchant is determined, the permanent geographic position of the merchant is determined, the current position of an offline target merchant is estimated, and the like.

The target merchant position information management method disclosed by the present embodiment solves the problem that position information of an offline user cannot be managed by managing the position information of the target merchant according to the information included in the resource transfer order by the second resource management client of the target merchant after the resource transfer order stored in the resource transfer terminal of the target merchant is acquired. The geographic position information management on the offline target merchant is realized, and the accuracy of the geographic position information management on the target merchant is greatly improved by acquiring geographic position information of the user during offline trading between the user and the target merchant, storing the geographic position information into the resource transfer order, and then, further using the geographic position information in the resource transfer order as the offline geographic position of the target merchant.

### Embodiment 9

The embodiment of the disclosure discloses a target merchant position information management system. As shown in FIG. 16, the system includes:

a resource transfer terminal 1622 with a built-in near field communication module or Bluetooth module;

a first resource management client 1620 and a second resource management client 1621, respectively performing data transmission with the resource transfer terminal 1622 by means of near field communication or Bluetooth communication; and

a resource management platform 1623, performing data transmission with the first resource management client 1620 or the second resource management client 1621 through a network and including a storage medium, a processor and a machine executable instruction stored in the storage medium and capable of running on the processor, where when the processor executes the machine executable instruction, the target merchant position information management method according to the embodiment of the disclosure is implemented.

The target user geographic position information management method disclosed by the embodiment of the disclosure is applied to the resource transfer system as shown in FIG. 16. The resource transfer system includes: a first resource management client 1620 of a user, a second resource management client 1621 of a target client, a resource transfer terminal 1622 of a target merchant and a resource management platform 1623. A near field communication module or a Bluetooth communication module is built in the resource transfer terminal 1622. In an offline resource transfer state, the resource transfer terminal 1622 performs data transmission with the first resource management client 1620 of the user by means of near field communication or Bluetooth communication. The resource transfer terminal 1622 and the second resource management client 1621 of the target merchant perform data transmission by means of near field communication or Bluetooth communication. The first resource management client 1620 and the resource management platform 1623 perform data transmission through the network. The near field communication module and the Bluetooth communication module have data transmission, data processing and storage functions. The first resource management client 1620 is client software installed in user equipment, and equipment provided with the first resource management client 1620 needs a built-in communication module matched with the resource transfer terminal 1622. The second resource management client 1621 of the target merchant is client software installed in target merchant equipment, and equipment provided with the second resource management client 1621 of the target merchant needs a built-in communication module matched with the resource transfer terminal 1622.

During specific implementation, the resource transfer terminal is a terminal with a built-in near field communication module or Bluetooth communication module. Preferably, the resource transfer terminal is a card type movable device. The resource transfer terminal is provided with a built-in near field communication module, and can work in a passive mode. The near field communication module includes an embedded secure element (eSE), a contactless frontend (CLF) chip (also called as NFC controller) and a near field communication (NFC) antenna. The embedded secure element includes a storage space, can run a preset program, and is configured to perform interaction with the first resource management client of the user to generate or store an offline resource transfer order. When the Bluetooth communication is built in the resource transfer terminal, the resource transfer terminal needs a built-in power supply to supply electricity to the Bluetooth communication module. The Bluetooth communication module includes a Bluetooth chip and a microcontroller. The microcontroller includes a storage space, can run a preset program, and is configured to perform interaction with the first resource management client of the user to generate or store the offline resource transfer order.

The present embodiment illustrates a specific implementation of the target merchant geographic position information management method in detail in conjunction with the specific application scenario of the target merchant geographic position information management method.

As shown in FIG. 17, the method includes specific application processes: step 1700 to step 1740.

Step 1700, a merchant signature of the target merchant is sent to the resource transfer terminal of the target merchant through the second resource management client of the target merchant.

During specific implementation, the resource transfer terminal is a terminal issued by the resource management platform to the target merchant and configured to perform online or offline payment. When the target merchant applies for enabling the resource transfer function of the resource transfer terminal through the second resource management client, the resource management platform generates the merchant signature of the target merchant according to registration information of the target merchant, such as a merchant name, and sends the merchant signature to the second resource management client of the target merchant through the network. Then, the second resource management client of the target merchant sends the merchant signature to the resource transfer terminal of the target merchant by means of near field communication or Bluetooth communication.

During specific implementation, in one embodiment, the offline resource transfer order is generated by the resource transfer terminal. In another embodiment, the offline resource transfer order is generated by the first resource management client. The present embodiment illustrates an offline resource transfer order generation scheme by taking the resource transfer terminal generating the offline resource transfer order as an example. That is, the offline resource transfer order is generated and stored by the resource transfer terminal according to an offline resource transfer request received by means of near field communication or Bluetooth communication.

Step 1710, the first resource management client of the user sends the offline resource transfer request to the resource transfer terminal of the target merchant by means of near field communication or Bluetooth communication according to an operation of the user.

During specific implementation, when the user transfers resources to the target merchant, the user initiates an offline resource transfer flow process through the first resource management client. By taking the resource transfer terminal being a built-in near field communication module as an example, the first resource management client may be client software installed in equipment (such as an NFC mobile phone) with a built-in near field communication module. Then, the user operates the first resource management client, and sends the offline resource transfer request to the resource transfer terminal of the target merchant by means of near field communication. The offline resource transfer request includes information such as the user signature of the user, the current geographic position of the user, the current time, and resource transfer content. The current geographic position may be a GPS position coordinate of the user.

Step 1720, the resource transfer terminal generates the offline resource transfer order according to the offline resource transfer request.

During specific implementation, the offline resource transfer order is generated and stored according to the merchant signature of the affiliated target merchant of the resource transfer terminal and the offline resource transfer request. The offline resource transfer request is sent by the user applying for resource transfer by means of near field communication or Bluetooth communication. The offline resource transfer request at least includes the geographic position of the user when the user sends the offline resource transfer request. The resource transfer terminal generates the offline resource transfer order according to information included in the received offline resource transfer request, such as the user signature of the user, the current geographic position, the current time and the resource transfer content, and the locally prestored single-time resource transfer quantity, and the target merchant signature. Then, the resource transfer terminal locally stores the generated offline resource transfer order, and sends successful acceptance information of the offline resource transfer order to the user by means of near field communication. Hereto, the user completes one offline resource transfer order by reading the resource transfer terminal of the target merchant.

Step 1730, the resource management platform acquires the offline resource transfer order stored in the resource transfer terminal of the target merchant through the second resource management client of the target merchant.

The offline resource transfer order is read by the second resource management client of the target merchant from the resource transfer terminal of the target merchant by means of near field communication or Bluetooth communication. During specific implementation, the resource management platform sends settlement notification or an instruction of acquiring the offline geographic position of the merchant resource transfer terminal to the second resource management client of the target merchant through the network, so as to acquire the offline resource transfer order of the target merchant. During specific implementation, in another embodiment, the target merchant actively reads the offline resource transfer order in the resource transfer terminal through the second resource management client, and uploads the offline resource transfer order to the resource management platform through the network.

During specific implementation, when both the resource transfer terminal and equipment of the merchant provided with the second resource management client are provided with built-in near field communication modules, the second resource management client of the merchant transmits the offline resource transfer order with the resource transfer terminal by means of near field communication. When both the resource transfer terminal and equipment of the merchant provided with the second resource management client are provided with built-in Bluetooth communication modules, the second resource management client of the merchant transmits the offline resource transfer order with the resource transfer terminal by means of Bluetooth communication.

Step 1740, the position information of the target merchant is managed according to information included in the offline resource transfer order.

During specific implementation, information included in the offline resource transfer order at least includes the geographic position. According to the information included in the offline resource transfer order, management on the position information of the target merchant includes: according to the geographic position included in the offline resource transfer order, the position information of the target merchant is managed; or according to the geographic position and the order time included in the offline resource transfer order, the position information of the target merchant is managed. The geographic position included in the offline resource transfer order is real-time geographic position of the user applying for generating the offline resource transfer order.

During specific implementation, the offline resource transfer order at least includes information such as the user signature of the resource transfer-out user, the target merchant signature, the order time, the geographic position, the resource transfer quantity and the order content. The geographic position is a geographic position where the offline resource transfer order is generated, i.e., a geographic position when the resource transfer-out user of the offline resource transfer order applies for generating the offline resource transfer order. According to different information included in the order, the geographic position information of the target merchant can be further managed. For example, according to the time and the geographic position in each offline resource transfer order, a conventional moving route of the target merchant and a permanent geographic position of the target merchant are determined, and a current position of an offline target merchant is estimated, etc.

In some embodiments, according to the geographic position included in the offline resource transfer order, management on the position information of the target merchant includes: for each offline resource transfer order, the geographic position included in the offline resource transfer order is used as one offline geographic position of the target merchant of the offline resource transfer order; and according to the respective offline geographic position of each target merchant, the permanent geographic position of the target merchant is determined.

During specific implementation, when the resource management platform acquires the offline resource transfer order stored in the resource transfer terminal, by analyzing the offline resource transfer order, the resource transfer-out user, the target merchant and the geographic position of each offline resource transfer order are determined. Then, for each offline resource transfer order, the included geographic position is taken to be used as the offline geographic position of the target merchant of the offline resource transfer order to construct an association relationship of the target merchant corresponding to each offline resource transfer order and the offline geographic position. Finally, according to the association relationship, the offline geographic position associated with each target merchant is respectively determined, and the offline geographic position associated with each target merchant is respectively subjected to clustering analysis to determine a cluster center including the most offline geographic positions as the permanent geographic position of the corresponding target merchant.

During offline trading of the user and the target merchant, the geographic position information of the user is acquired, and is stored into the offline resource transfer order. Then, the geographic position information in the offline resource transfer order is further analyzed, so as to acquire the offline geographic position of the target merchant to further perform geographic position information management on the target merchant according to the offline geographic position, so that the accuracy of the geographic position information management is improved.

In some embodiments, according to the geographic position and order time included in the offline resource transfer order, management on the position information of the target merchant includes: for each offline resource transfer order, the geographic position included in the offline resource transfer order is used as one offline geographic position of the target merchant of the offline resource transfer order, and the order time included in the offline resource transfer order is used as the time of the target merchant appearing in the offline geographic position; and a moving route of the target merchant is determined according to each offline geographic position of the target merchant and the time when each offline geographic position is recorded.

During specific implementation, after the resource management platform acquires the offline resource transfer order stored by the resource transfer terminal, by analyzing the offline resource transfer order, the resource transfer-out user, the target merchant, the order time and the geographic position of each offline resource transfer order are determined. Then, for each offline resource transfer order, the included geographic position is taken to be used as the offline geographic position of the target merchant of the offline resource transfer order. The included order time is used as the time of the target merchant of the offline resource transfer order appearing in the offline geographic position, and the association relationship among the target merchant corresponding to each offline resource transfer order, the offline geographic position and the appearing time is constructed. Finally, according to the association relationship, the associated offline geographic position of each target merchant and the time of appearing in each associated offline geographic position are respectively determined, and the moving route of each target merchant is trained through a machine learning model. Or, firstly, each day is divided into a preset quantity of time periods. Then, for each target merchant, the offline geographic position of the target merchant appearing in each time period is determined. Next, the most frequently appearing offline geographic position of the target merchant in each time period is selected to be used as the permanent geographic position of the target merchant in the time period. Finally, according to the sequence of the time periods, the moving route of the target merchant in a day, i.e., the appearing geographic position of the target merchant in different time periods in a day is determined.

By combining the order time and the geographic position of the offline resource transfer order, the geographic position information of the target merchant is analyzed to determine the moving route of the target merchant, so that the resource management platform can predict the current position of the target merchant according to the moving route under the condition that the target merchant is offline. When the merchant is subjected to position information management, it mainly relies on the self-position information reported by the merchant in real time, such as GPS positioning information reported in real time by a mobile terminal. When the merchant is offline, the merchant cannot be positioned. By using the target merchant position information management method disclosed by the embodiment of the present disclosure, the geographic position of the merchant can be determined according to the geographic position of the user, so that it is possible to manage the position information of the offline target merchant, and a necessary condition is provided for the service based on the geographic position of the merchant.

In other embodiments of the disclosure, the offline resource transfer order is generated by the first resource management client of the user applying for the target merchant for resource transfer, and is sent to the resource transfer terminal and stored by means of near field communication or Bluetooth communication.

For example, the user firstly sends a request of acquiring authentication information of the resource transfer terminal of the target merchant through the first resource management client, and performs identity authentication on the resource transfer terminal according to the acquired authentication information of the resource transfer terminal. Then, the first resource management client of the user generates the offline resource transfer order according to the resource transfer quantity input by the user, the pre-acquired user signature and target merchant signature, the current geographic position of host equipment of the first resource management client, the current time, and other order information. Finally, the first resource management client of the user sends the offline resource transfer order to the resource transfer terminal and to be stored by means of near field communication or Bluetooth communication.

During specific implementation, when both the resource transfer terminal and the host equipment of the first resource management client are provided with built-in near field communication modules, the first resource management client of the user and the resource transfer terminal transmit the offline resource transfer order and other resource transfer-related information by means of near field communication. When both the resource transfer terminal and the host equipment of the first resource management client of the user are provided with built-in Bluetooth communication modules, the first resource management client of the user and the resource transfer terminal transmit the offline resource transfer order and other resource transfer-related information by means of Bluetooth communication.

According to the target merchant position information management method disclosed by the present embodiment, after the offline resource transfer order stored in the resource transfer terminal of the target merchant is acquired through the second resource management client of the target merchant, the position information of the target merchant is managed according to the information included in the offline resource transfer order, so that the problem that the position information management cannot be performed on the offline user is solved. According to the target merchant position information management method disclosed by the present embodiment, the user applies for resource transfer to the merchant by means of near field communication or Bluetooth communication, so as to generate the offline resource transfer order. The position information in the offline resource transfer order is a geographic position of the user performing resource transfer to the target merchant, such as a GPS position coordinate. By using the geographic position of the user performing resource transfer to the target merchant as the offline geographic position of the target merchant, the management on the position information of the offline target merchant becomes possible.

### Embodiment 10

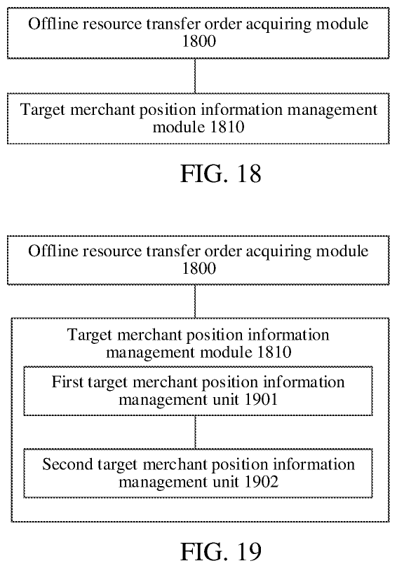

The present embodiment discloses a target merchant position information management device. As shown in FIG. 18, the device includes:

an offline resource transfer order acquiring module 1800, configured to acquire an offline resource transfer order stored in a resource transfer terminal of a target merchant through a second resource management client of the target merchant; and

a target merchant position information management module 1810, configured to manage position information of the target merchant according to information included in the offline resource transfer order acquired by the offline resource transfer order acquiring module 1800.

The information included in the offline resource transfer order at least includes a geographic position.

The target merchant position information management device disclosed by the present embodiment solves the problem that position information of an offline user cannot be managed by managing the position information of the target merchant according to information included in the offline resource transfer order by a first resource management terminal of the target merchant after the offline resource transfer order stored in the resource transfer terminal of the target merchant is acquired. The geographic position information management on an offline target merchant is realized, and the accuracy of the geographic position information management on the target merchant is greatly improved by acquiring the geographic position information of the user during offline trading between the user and the target merchant, storing the geographic position information into the offline resource transfer order, and then, further using the geographic position information in the offline resource transfer order as an offline geographic position of the target merchant.

In some embodiments, as shown in FIG. 19, the target merchant position information management module 1810 further includes:

a first target merchant position information management unit 1901, configured to manage the position information of the target merchant according to the geographic position included in the offline resource transfer order; or

a second target merchant position information management unit 1902, configured to manage the position information of the target merchant according to the geographic position and an order time included in the offline resource transfer order.

The geographic position included in the offline resource transfer order is a real-time geographic position when the user applies for generating the offline resource transfer order.

During specific implementation, the offline resource transfer order at least includes information such as a user signature of a resource transfer-out user, a target merchant signature, the order time, the geographic position, the resource transfer quantity and the order content. The geographic position is a geographic position where the offline resource transfer order, i.e., the geographic position when the resource transfer-out user in the offline resource transfer order applies to generate the offline resource transfer order, is generated. According to different information included in the order, the geographic position information of the target merchant can be further managed. For example, according to the time and the geographic position in each offline resource transfer order, a conventional moving route of the target merchant is determined, a permanent geographic position of the merchant is determined, a current position of the offline target merchant is pre-estimated, etc.

In some embodiments, the first target merchant position information management unit 1901 is further configured to:

for each offline resource transfer order, use the geographic position included in the offline resource transfer order as one offline geographic position of the target merchant of the offline resource transfer order; and

according to the respective offline geographic position of each target merchant, determine the permanent geographic position of the target merchant.

In some embodiments, the second target merchant position information management unit 1902 is further configured to:

for each offline resource transfer order, use the geographic position included in the offline resource transfer order as one offline geographic position of the target merchant of the offline resource transfer order, and use the order time included in the offline resource transfer order as the time of the target merchant appearing in the offline geographic position; and

according to the respective offline geographic position of each target merchant and the time of appearing in each offline geographic position, determine the moving route of the target merchant.

According to the target merchant position information management method disclosed by the present embodiment, the user applies for resource transfer to the merchant by means of near field communication or Bluetooth communication, so as to generate the offline resource transfer order. The position information in the offline resource transfer order is a geographic position of the user performing resource transfer to the target merchant, such as a GPS position coordinate. By using the geographic position of the user performing resource transfer to the target merchant as the offline geographic position of the target merchant, the management on the position information of the offline target merchant becomes possible.

In some embodiments, the offline resource transfer order is read from the resource transfer terminal of the target user by the first resource management client of the target user by means of near field communication or Bluetooth communication.

In some embodiments, the offline resource transfer order is generated and stored by the resource transfer terminal through the offline resource transfer request received by means of near field communication or Bluetooth communication, or the offline resource transfer order is generated by the first resource management client of the user applying to the target client for resource transfer, and is sent to the resource transfer terminal to be stored by means of near field communication or Bluetooth communication.

Under the condition that the user and the target merchant are not connected to the network, the generation and acceptance of the resource transfer order are completed by means of near field communication or Bluetooth communication, and the resource transfer order is stored in the resource transfer terminal of the target merchant, so as to subsequently complete resource transfer through the resource management platform. Therefore, resource transfer between the user and the target merchant is more flexible, and a resource transfer system is facilitated for use in various use environments.

The payment flexibility is improved by WeChat code scanning payment in one example. For mobile merchants, the WeChat code scanning payment is performed, and certain convenience is brought to the user and the merchant. However, for the WeChat code scanning payment, a mobile phone of the user needs to be connected to the network. The acceptance of the payment order cannot be completed without being connected to the network. For near field communication (NFC) (i.e., near field communication technology) payment, generally, the resource transfer terminal (such as a POS machine) of a merchant is required to be in a network connected state. The acceptance of the payment order can also be not completed without being connected to the network. Additionally, under the two conditions, the offline position information of the merchant is not managed, only the order position reported by the merchant is recorded in the online payment order for inquiry.

Correspondingly, the application further discloses electronic equipment, including a storage medium, a processor and a machine executable instruction stored in the storage medium and capable of running on the processor. When the processor executes the machine executable instruction, the target merchant position information management method according to Embodiment 8 and Embodiment 9 of the application is implemented. The electronic equipment may be a PC machine, a mobile terminal, a personal digital assistant, a tablet computer, an intelligent loudspeaker and the like.

The embodiments in this specification are all described in a progressive manner, each embodiment focuses on a difference from other embodiments, and for same or similar parts in the embodiments, mutual reference may be made to these embodiments. An apparatus embodiment is basically similar to a method embodiment, and therefore is described briefly. For related parts, refer to partial descriptions in the method embodiment.

The resource transfer method, device and system based on near field communication provided by the disclosure are described above in detail. Specific examples are used in this specification to describe the principle and implementation manners of the disclosure, but the foregoing descriptions of the embodiments are merely intended to help understand the method of the disclosure and the core idea thereof. Besides, a person of ordinary skill in the art may make alterations to the specific implementation manners and application scope according to the idea of the disclosure. In conclusion, the content of this specification shall not be understood as a limitation on the disclosure.

Based on the descriptions of the foregoing implementations, a person skilled in the art can clearly understand that the embodiments can be implemented by software and a necessary universal hardware platform or by hardware only. Based on such an understanding, the foregoing technical solutions essentially or the part contributing to the related technology can be implemented in a form of a software product. The computer software product is optionally stored in a computer-readable storage medium, such as a read-only medium (ROM)/a random access memory (RAM), a magnetic disk, or an optical disc, and includes several instructions for instructing a computer device (which is optionally a personal computer, a server, a network device, or the like) to perform the methods of the embodiments or some parts of the embodiments.

What is claimed is:

1. A resource transfer method based on near field communication, comprising:
acquiring a user identifier of a current login user in a first resource management client by a resource transfer terminal of a target merchant in response to triggering of the first resource management client, wherein the resource transfer terminal comprises a near field communication module;
in response to determining that the resource transfer terminal has enabled a fixed quantity resource transfer mode, generating a resource transfer order by the resource transfer terminal according to a preset quantity of resources transferred by a single order;
adding a merchant signature of the target merchant and a user signature generated according to the acquired user identifier to the resource transfer order by the resource transfer terminal, and accepting the resource transfer order with the signatures; and
sending an acceptance state of the resource transfer order with the signatures to the first resource management client by the resource transfer terminal by means of near field communication,
wherein the fixed quantity resource transfer mode and the quantity of resources transferred by each order are set according to data sent by a second resource management client.

2. The method according to claim 1, further comprising:
outputting the accepted resource transfer order with the signatures by the resource transfer terminal in response to triggering of the second resource management client, so that the second resource management client completes resource transfer corresponding to the resource transfer order with the signatures through a resource management platform.

3. The method according to claim 2, wherein after the step of acquiring the user identifier of the current login user in the first resource management client by the resource transfer terminal of the target merchant in response to triggering of the first resource management client, the method further comprises:
receiving the resource transfer order sent by the first resource management client by means of near field communication by the resource transfer terminal;
adding the merchant signature of the target merchant and the user signature generated according to the acquired user identifier to the resource transfer order by the resource transfer terminal, and accepting the resource transfer order with the signatures; and
sending an acceptance state of the resource transfer order with the signatures to the first resource management client by the resource transfer terminal by means of near field communication.

4. The method according to claim 1, further comprising:
receiving a user blacklist sent by the second resource management client by the resource transfer terminal by means of near field communication, and storing the user blacklist; and
in response to that the user identifier corresponds to a user in the user blacklist, sending a backlist setting instruction of setting the user into a blacklist user to the first resource management client by means of near field communication, and removing the user identifier from the user blacklist.

5. The method according to claim 1, further comprises:
performing encryption processing on the resource transfer order with the signatures through a preset key by the resource transfer terminal, before the resource transfer order with the signatures is accepted.

6. A target merchant position information management method based on near field communication, comprising:
acquiring at least one resource transfer order stored in a resource transfer terminal by a second resource management client; and
managing position information of a target merchant by the second resource management client according to information comprised in the resource transfer order,
wherein the information comprised in the resource transfer order at least comprises a geographic position.

7. The method according to claim 6, wherein the step of managing the position information of the target merchant by the second resource management client according to the information comprised in the resource transfer order comprises:
managing the position information of the target merchant by the second resource management client according to the geographic position comprised in the resource transfer order; or
managing the position information of the target merchant by the second resource management client according to the geographic position and order time comprised in the resource transfer order,
wherein the geographic position comprised in the resource transfer order is a real-time geographic position of the resource transfer terminal when generating the resource transfer order.

8. The method according to claim 7, wherein the step of managing the position information of the target merchant by the second resource management client according to the geographic position comprised in the resource transfer order comprises:
using the geographic position comprised in the resource transfer order as an offline geographic position of the target merchant corresponding to the resource transfer order by the second resource management client; and
determining a permanent geographic position of the target merchant by the second resource management client according to each offline geographic position of the target merchant.

9. The method according to claim 7, wherein the step of managing the position information of the target merchant by the second resource management client according to the geographic position and the order time comprised in the resource transfer order comprises:
using the geographic position comprised in the resource transfer order as an offline geographic position of the target merchant corresponding to the resource transfer order, and using the order time comprised in the resource transfer order as the time of the target merchant appearing in the offline geographic position by the second resource management client; and
determining a moving route of the target merchant by the second resource management client according to each offline geographic position of the target merchant and the time of appearing in each offline geographic position.

10. The method according to claim 6, wherein the resource transfer order is read by the second resource management client from the resource transfer terminal of the target merchant by means of near field communication or Bluetooth communication.

11. The method according to claim 6, wherein before the step of acquiring at least one resource transfer order stored in the resource transfer terminal by the second resource management client, the method further comprises:
performing merchant registration on a resource management platform by the second resource management client through a network, so as to acquire target merchant authentication information of the target merchant;
receiving a key issued by the resource management platform by the second resource management client, wherein the key comprises a trading key or a transmission key; and
sending the target merchant authentication information and the key to the resource transfer terminal to be stored by the second resource management client by means of near field communication.

12. Electronic equipment, comprising:
a storage medium;
a processor; and
machine executable instructions stored in the storage medium and capable of running on the processor;
wherein the processor executes the machine executable instructions to implement operations comprising:
acquiring at least one resource transfer order stored in a resource transfer terminal; and
managing position information of a target merchant according to information comprised in the resource transfer order,
wherein the information comprised in the resource transfer order at least comprises a geographic position.

13. The electronic equipment according to claim 12, wherein the operations further comprising:
managing the position information of the target merchant according to the geographic position comprised in the resource transfer order,
wherein the geographic position comprised in the resource transfer order is a real-time geographic position of the resource transfer terminal when generating the resource transfer order.

14. The electronic equipment according to claim 13, wherein the operations further comprising:
using the geographic position comprised in the resource transfer order as an offline geographic position of the target merchant corresponding to the resource transfer order; and
determining a permanent geographic position of the target merchant according to each offline geographic position of the target merchant.

15. The electronic equipment according to claim 12, wherein the operations further comprising:
managing the position information of the target merchant according to the geographic position and an order time comprised in the resource transfer order,
wherein the geographic position comprised in the resource transfer order is a real-time geographic position of the resource transfer terminal when generating the resource transfer order.

16. The electronic equipment according to claim 15, wherein the operations further comprising:
using the geographic position comprised in the resource transfer order as an offline geographic position of the target merchant corresponding to the resource transfer order, and using the order time comprised in the resource transfer order as the time of the target merchant appearing in the offline geographic position; and
determining a moving route of the target merchant according to each offline geographic position of the target merchant and the time of appearing in each offline geographic position.

17. The electronic equipment according to claim 12, wherein the resource transfer order is read by the processor from the resource transfer terminal of the target merchant by means of near field communication or Bluetooth communication.

18. The electronic equipment according to claim 12, wherein the operations further comprising:
performing merchant registration on a resource management platform through a network, so as to acquire target merchant authentication information of the target merchant;
receiving a key issued by the resource management platform, wherein the key comprises a trading key or a transmission key; and
sending the target merchant authentication information and the key to the resource transfer terminal and to be stored by means of near field communication.
